(19) United States
(12) Patent Application Publication
(10) Pub. No.: US 2026/0181448 A1
(43) Pub. Date: Jun. 25, 2026

(54) MEASUREMENT REPORTING FOR ACTIVATION OF NETWORK ENERGY SAVING

(71) Applicant: Telefonaktiebolaget LM Ericsson (publ), Stockholm (SE)

(72) Inventors: Pål Frenger, Linköping (SE); Pradeepa Ramachandra, Linköping (SE); Ali Nader, Malmö (SE); Sina Maleki, Malmö (SE)

(21) Appl. No.: 19/126,488

(22) PCT Filed: Nov. 28, 2023
(86) PCT No.: PCT/EP2023/083325

§ 371 Date: May 1, 2025

Related U.S. Application Data
(60) Provisional application No. 63/428,750, filed on Nov. 30, 2022.

(51) Int. Cl. H04W 24/10; H04W 36/16

(52) U.S. Cl. CPC H04W 24/10; H04W 36/165

(57) ABSTRACT

Methods performed by a wireless device for communicating in a wireless communication network are provided. The method comprises receiving a signal comprising an indication to transmit one or more measurement reports from a first network node or a second network node, where each measurement report is associated with a measurement configuration out of one or more measurement configurations. The method further comprises transmitting the one or more measurement reports to the first network node or to the second network node. Corresponding methods performed by a network node for communicating in a wireless network are also provided.

### TECHNICAL FIELD

The present disclosure relates to wireless communications, and in particular to measurement reporting for activation of network energy saving.

### INTRODUCTION

Network energy saving is of great importance for environmental sustainability, to reduce environmental impact (greenhouse gas emissions), and for operational cost savings. As 5G is becoming pervasive across industries and geographical areas, handling more advanced services and applications requiring very high data rates (e.g. Mixed Reality, XR), networks are being denser, use more antennas, larger bandwidths and more frequency bands. The environmental impact of 5G needs to stay under control, and novel solutions to improve network energy savings need to be developed.

### SUMMARY

It is an object of the herein disclosed technology to provide methods performed by a wireless device, wireless devices, methods performed by a network node, network nodes, and other related aspects, which seek to mitigate, alleviate, or eliminate one or more of the deficiencies in the art and disadvantages singly or in any combination.

This object is achieved by means of method performed by a wireless device, wireless device, method performed by a network node, a network node, a computer program product, and a (non-transitory) computer-readable storage medium as defined in the appended claims.

Some embodiments advantageously provide methods performed by a wireless device, wireless devices, methods performed by a network node, and network nodes employing a measurement reporting framework that allows for more dynamic reporting functionality, suitable for execution of network energy saving techniques and/or mobility load balancing/sharing, than currently known solutions.

Some embodiments advantageously provide methods performed by a wireless device, wireless devices, methods performed by a network node, and network nodes for employing a measurement reporting framework that enable network energy saving techniques and/or mobility load balancing/sharing with reduced processing overhead and reduced over-the-air resource usage as compared to currently known solutions.

Some embodiments advantageously provide methods performed by a wireless device, wireless devices, methods performed by a network node, and network nodes employing a measurement reporting framework that facilitates the implementation of network energy saving techniques and/or mobility load balancing/sharing.

The terms “network energy saving technique” and “network energy saving function” are used interchangeably herein.

An aspect of the herein disclosed technology comprises a method performed by a wireless device in a wireless communication network. The method comprises receiving a signal comprising an indication to transmit one or more measurement reports from a first network node or a second network node, where each measurement report is associated with a measurement configuration out of one or more measurement configurations. The method further comprises transmitting the one or more measurement reports to the first network node or to the second network node.

Another aspect of the herein disclosed technology comprises a wireless device for communication with radio nodes in a wireless communication network. The wireless device comprises processing circuitry configured to execute the method suitably performed by a wireless device according to any one of the embodiments disclosed herein. With this aspect of the disclosure, similar advantages and preferred features are present as in the previously discussed aspect of the disclosure.

Another aspect of the herein disclosed technology comprises a method performed by a network node for communicating with a wireless device in a wireless communication network. The method comprises transmitting, to the wireless device, a signal comprising an indication of a request for one or more measurement reports. The one or more measurement reports are associated with one or more measurement configurations of the wireless device. The method further comprises receiving the one or more measurement reports from the wireless device, and performing a network energy saving function or a load balancing/sharing function based on the received one or more measurement reports. With this aspect of the disclosure, similar advantages and preferred features are present as in the previously discussed aspects of the disclosure.

Further, another aspect of the present disclosure comprises a network node configured to communicate with a wireless device in a wireless communication network, the network node comprising processing circuitry configured to execute the method performed by a network node according to any one the embodiments herein. With this aspect of the disclosure, similar advantages and preferred features are present as in the previously discussed aspects of the disclosure.

According to some embodiments, there is provided a computer program product comprising instructions which, when the computer program is executed by one or more processors of a computing device, causes the computing device to carry out the method according to any one of the embodiments disclosed herein. With this aspect of the disclosure, similar advantages and preferred features are present as in the previously discussed aspects of the disclosure.

According to some embodiments, there is provided a (non-transitory) computer-readable storage medium comprising instructions which, when executed by one or more processors of a computing device, causes the computing device to carry out the method according to any one of the embodiments disclosed herein. With this aspect of the disclosure, similar advantages and preferred features are present as in the previously discussed aspects of the disclosure.

The term “non-transitory,” as used herein, is intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link. Thus, the term “non-transitory”, as used herein, is a limitation of the medium itself (i.e., tangible, not a signal) as opposed to a limitation on data storage persistency (e.g., RAM vs. ROM).

The disclosed aspects and example embodiments may be suitably combined with each other in any manner apparent to anyone of ordinary skill in the art, such that one or more features or embodiments disclosed in relation to one aspect may also be considered to be disclosed in relation to another aspect or embodiment of another aspect.

Further embodiments of the disclosure are defined in the appended dependent embodiments and the detailed description below. It should be emphasized that the term “comprises/comprising” when used in this specification is taken to specify the presence of stated features, integers, steps, or components. It does not preclude the presence or addition of one or more other features, integers, steps, components, or groups thereof.

An advantage of some embodiments the network is able to obtain measurement reports from the UEs as and when it wants without needing to send new measurement configurations to the UE at the time of needing the measurement reports. Thus, the RAN node can use these measurement reports to enable functionalities like network energy savings and mobility load balancing/sharing.

An advantage of some embodiments is that the network is provided with a more dynamic and on-demand reporting from the UEs, which allows the network nodes to employ network energy saving functionalities and/or mobility load balancing/sharing.

These and other features and advantages of the present disclosure will in the following be further clarified with reference to the embodiments described hereinafter.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 is a schematic illustration of a first network node, a second network node and a wireless device in a wireless communications network.

FIG. 2 is a schematic flowchart representation of a method performed by a wireless device in accordance with some embodiments.

FIG. 3 is a schematic block diagram representation of a wireless device for communication with a network node in a wireless communication network in accordance with some embodiments.

FIG. 4 is a schematic flowchart representation of a method performed by a network node for communicating with a wireless device in a wireless communication network in accordance with some embodiments.

FIG. 5 is a schematic block diagram representation of a network node for communicating with a wireless device in a wireless communication network in accordance with some embodiments.

FIG. 6 is a schematic signaling diagram illustrating a method in accordance with some embodiments.

FIG. 7 is a schematic signaling diagram illustrating a method in accordance with some embodiments.

FIG. 8 is a schematic signaling diagram illustrating a method in accordance with some embodiments.

FIG. 9 is a schematic signaling diagram illustrating a method in accordance with some embodiments.

FIG. 10 is a schematic signaling diagram illustrating a method in accordance with some embodiments.

FIG. 11 is a schematic signaling diagram illustrating a method in accordance with some embodiments.

FIG. 12 schematically illustrates a telecommunication network connected via an intermediate network to a host computer in accordance with some embodiments.

FIG. 13 is a generalized block diagram of a host computer communicating via a base station with a user equipment over a partially wireless connection in accordance with some embodiments.

FIGS. 14-17 are flowchart representations of methods implemented in a communication system including a host computer, a base station and a user equipment, in accordance with some embodiments.

### DETAILED DESCRIPTION

Aspects of the present disclosure will be described more fully hereinafter with reference to the accompanying drawings. The control device and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not necessarily intended to limit the scope. As used herein, the singular forms “a”, “an” and “the” are intended to include the plural forms as well, unless the context clearly indicates otherwise. The terminology “at least one of A and B” should in the present context be read as A and/or B, where A and B can be any arbitrary items or elements in a set.

Those skilled in the art will appreciate that the steps, services and functions explained herein may be implemented using individual hardware circuitry, using software functioning in conjunction with a programmed microprocessor or general purpose computer, using one or more Application Specific Integrated Circuits (ASICs) and/or using one or more Digital Signal Processors (DSPs). It will also be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate, and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, integrated access and backhaul (IAB) node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node. Moreover, a network node may also be in the form of a sub-entity of a BTS, such as e.g. a Centralized Unit (CU) or a Distributed Unit (DU).

In some embodiments, the non-limiting terms wireless device (WD) or a user equipment (UE) are used interchangeably. The WD herein can be any type of wireless device capable of communicating with a network node or another WD over radio signals. The WD may be a user device. The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

It should be noted that the term wireless device, or in particular, the term user equipment (UE) may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE may be any UE identified by the 3rd Generation Partnership Project (3GPP), including a NB-IoT UE, a machine type communication (MTC) UE, and/or an enhanced MTC (eMTC) UE.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

### Overview

A brief overview of the measurement framework in 5G/NR is provided below. Accordingly, in some embodiments, the “measurements” performed by the UE/WD or “measurement reports” transmitted by the UE/WD may include one or more of the following examples. It should also be noted that the examples below are non-exhaustive, and the UE may be configured to perform other measurements as readily understood by the skilled person in the art.

The network may configure the UE to perform the following types of measurements:
NR measurements.
Inter-RAT measurements of E-UTRA frequencies.
Inter-RAT measurements of UTRA-FDD frequencies.

The network may configure the UE to report the following measurement information based on SS/PBCH block(s):
Measurement results per SS/PBCH block;
Measurement results per cell based on SS/PBCH block(s);
SS/PBCH block(s) indexes.

The network may configure the UE to report the following measurement information based on Channel State Information Reference Signal CSI-RS resources:
Measurement results per CSI-RS resource;
Measurement results per cell based on CSI-RS resource(s);
CSI-RS resource measurement identifiers.

The network may configure the UE to perform the following types of measurements for sidelink:
CBR measurements.

The network may configure the UE to report the following CLI measurement information based on SRS resources:
Measurement results per SRS resource.
SRS resource(s) indexes.

The network may configure the UE to report the following CLI measurement information based on CLI-RSSI resources:
Measurement results per CLI-RSSI resource.
CLI-RSSI resource(s) indexes.

In NR, measurement configuration/re-configuration is performed by explicitly signaling, based on the MeasConfig of IE MeasConfig. The network may configure an RRC_CONNECTED UE to perform measurements. The network may configure the UE to report them in accordance with the measurement configuration or perform conditional reconfiguration evaluation in accordance with the conditional reconfiguration. The measurement configuration is provided by means of dedicated signaling i.e. using the RRCReconfiguration or RRCResume. The Information Element, IE, MeasConfig specifies measurements to be performed by the UE, and covers intra-frequency, inter-frequency and inter-RAT mobility as well as configuration of measurement gaps.

In the particular case when a handover is triggered (or more generally, reconfiguration with sync, that also includes PSCell addition and PSCell change), the source gNB determines to trigger a handover and transmits in a Handover Preparation container to the target gNB the current measurement configuration the UE (as part of the Access Stratum, AS, context of the UE). Upon reception, the target gNB may accept the handover request and generate an RRCReconfiguration to be applied by the UE. That RRCReconfiguration may include a MeasConfig measurement configuration generated by the target gNB, taking into account the need codes of the IE MeasConfig e.g. not including a field with need code M indicates to the UE that the UE is to use in target gNB the same configuration as in source gNB. Further details of this process are described in 3GPP TS 38.300 V17.1.0, and in particular in FIG. 9.2.3.2.1-1: Intra-AMF/UPF Handover, and the associated passages of section 9.2.3.2.1.

The RRM configuration can include both beam measurement information (for layer 3 mobility) associated to System Synchronization Block(s) (SSB(s)) and Channel State Information Reference Signal(s) (CSI-RS(s)) for the reported cell(s) if both types of measurements are available. Also, if Carrier Aggregation, CA, is configured, the RRM configuration can include the list of best cells on each frequency for which measurement information is available. And the RRM measurement information can also include the beam measurement for the listed cells that belong to the target gNB.

Furthermore, in RRC, the reception of an RRCReconfiguration (during the handover) leads to the procedure described in section 5.3.5 of 3GPP TS 38.331 V17.2.0, and in particular, to the procedure described in sub-section 5.3.5.3.

Further, there have been some initiatives to explore solutions for network energy savings, where the one objective is to study and identify techniques on the gNB and UE side to improve network energy savings in terms of both BS transmission and reception. In order to facilitate further understanding of the term “network energy saving techniques” or “network energy saving function”, the following provides some examples of what a network energy saving technique may comprise in accordance with some embodiments.

In accordance with some embodiments, the network energy saving function comprises one or more spatial domain energy saving techniques. In more detail, gNBs with active antenna systems generally employ a large number of antenna elements arranged in subarrays. It is quite common today that such gNBs are equipped with 64 and above such Rx/Tx chains, and more are foreseen in the future, especially at higher frequencies. The energy consumed by the multitude of these transceiver chains stands for a substantial part of total consumed network energy. For efficient beam management, this also results in a higher number of reference signal transmissions such as CSI-RSs which in turn, due to excessive number of radio wakeups, is quite energy consuming. Not all UEs in connected mode benefit from all these transmissions and activated transceiver-related circuits, e.g., when the UEs are close enough to the gNB, or when the load is low or medium and the capacity which is provided by the higher number of antennas is underutilized. Energy savings can be achieved by muting a portion of the transceivers whereby the involved circuitry is turned off. Thus, in some embodiments, performing a network energy saving function comprises employing a spatial domain energy saving technique, such as e.g. turning off one or more RX/TX/TRX chains of the network node out of a plurality of RX/TX/TRX chains available to the network node. The term “turning off” one or more RX/TX/TRX chains may be understood as setting them in an idle/sleep mode, muting them, or turning off the associated circuitry.

In accordance with some embodiments, the network energy saving function comprises one or more time domain energy saving techniques. In more detail, techniques that allow the network to apply one of the appropriate sleep modes depending on the available inactive time (or sleep opportunity). The inactive time in this case may be understood as the time over which the gNB does not need to transmit or receive. A gNB, at least on a serving PCell, needs to transmit specific signals and messages periodically, e.g., SSBs, SIBs, periodic Tracking Reference Signal (TRS), and if configured, periodic CSI-RS, and so on. There may also be frequent paging transmissions including associated Permanent Equipment Identifier (PEI) transmissions for potential UE energy savings in idle mode. Furthermore, the gNB needs to at least listen to PRACH for potential UEs accessing the cell even if no other UL grants are given. In short, NR is designed very lean, e.g., SSB periodicity of 20 ms, and as such, ideally if there is nothing to transmit or receive between two SSB transmissions, the gNB should be able to go to light sleep and save significant amount of energy. Therefore, it is desirable to minimize the number of such operations between two SSB transmissions to the absolute necessity in order for the network to be able to go to deeper sleep than micro sleep. Thus, in some embodiments, performing a network energy saving function comprises employing a time domain energy saving technique, such as e.g. setting one or more parts or functions of the network node in a sleep mode.

In accordance with some embodiments, the network energy saving function comprises one or more power domain energy saving techniques. Currently the DL transmission power is typically fixed by the gNB for all UEs in a cell. UEs in good coverage may experience very high SINR levels and it may be possible that even with the highest MCS, the received power may still be higher than required for the specific scenario. For such scenarios, it is useful in terms of energy consumption to reduce the gNB transmission power specifically for the UEs in good coverage. Thus, in some embodiments, performing a network energy saving function comprises employing a power domain energy saving technique, such as e.g. reducing a transmission power for signals to be transmitted to a UE.

In accordance with some embodiments, the network energy saving function comprises one or more frequency/carrier domain energy saving techniques. Energy saving techniques in the frequency domain can be divided to techniques which saves on e.g., reduced BW and techniques which saves energy in Scells:
Current BWP adaptation provides a good tool for the network to adapt both its own BW as well as UE's operating BW. For certain transmissions, the network can adapt its BW quite fast, and UE can also benefit from this adaptation, e.g., if the network reduces the BW for transmitting PDCCH to save energy, so does the UE.
Current standards provide good tools for the network to reduce energy consumption on the SCells both for itself and also for the UE, e.g., by deactivating SCells, SCell dormancy, etc. Transmission of less RSs on SCells can further reduce the network energy consumption, and particularly if there is not much activity on the cell, provide a longer sleep time.

Thus, in accordance with some embodiments, performing a network energy saving function comprises employing a frequency/carrier domain energy saving technique, such as e.g. reducing a bandwidth (BW) for transmitting PDCCH to a UE, deactivating one or more SCells, configuring the network node so to transmit a lower number of RSs on one or more SCells.

A common aspect for all of the above-mentioned network energy saving techniques is that activation/execution of any one the network energy saving techniques has an impact on the capabilities of a cell to serve traffic. For some network energy saving techniques, the traffic serving capabilities are reduced (e.g. BWP adaptation, MIMO sleep, etc.) and for other techniques the traffic serving capability of a cell in energy saving mode is zero (e.g. deactivation of SCells). However, it is desirable that the (overall) network can still serve the traffic in an area with sufficient quality, even when some network energy saving techniques are active in individual network nodes. In some embodiments, a network energy saving technique may be enabled by load balancing/sharing of traffic between cells/nodes. In more detail, in some embodiments, performing a load balancing/sharing function comprises moving a set of UEs to another cell, which may be provided by another network node. Thereby, it may be possible for a cell/node to reduce the bandwidth, transmission power, or number of active antenna branches without making any, or at least a no significant, negative impact on the service from the network as experienced by the associated UEs. Accordingly, if active UEs can be handed over to other cells/nodes, where they are expected to be sufficiently served, capacity cells (i.e. SCells) may be deactivated completely with little-to-no negative effect on network service provided to the associated UEs.

However, without measurements from the UEs, the network will have limited knowledge of what energy saving techniques that may currently be possible to activate. The current RRC measurement reporting framework involves a UE to be configured with relevant intra-inter frequency related measurement configurations, and the UE sends a measurement report when the measurement reporting triggering conditions are met. This measurement report is generally used for taking decisions on handover candidate selection, handover setup, carrier aggregation candidate selection, etc.

This process or method has the limitation that the network needs to either know all the use cases (e.g., handover, carrier aggregation candidate selection) for which it wants the UE to send a measurement report. The reporting criterion (e.g., periodical or an event that states the criterion for triggering the measurement report) that has been configured needs to be pre-known as per the usefulness in the use case in which the measurement report is expected to be used. This leads to limitations in that a network node needs to reconfigure the UEs with new measurement conditions and reporting conditions if the network node wants to perform a new operation based on the measurement reports from the UE. Consider the following network energy saving and load balancing examples below that exemplify the problem.

A first example or scenario could be when a network node decides to enable the network energy saving feature, and it would like to gracefully handover all the UEs to the neighboring cells before turning itself off. In such a case, the network node needs to know which UE could be served with which other neighboring cell (intra frequency and/or inter-frequency) so that it can initiate a handover procedure. However, none of the connected UEs might have sent a measurement report that would have resulted in a handover procedure as the measurement report triggering conditions configured for the handover might not have been met.

In order to overcome this issue, the network node can configure periodical reporting so that it can get to know the radio quality as experienced by the UE on different frequencies at a regular interval so that it can always readily take any action based on these reports. However, the periodical reporting is a large overhead for the UEs and for the network in terms of processing overhead and also the over-the-air resource usage.

Another way to overcome the issue could be for the network node to configure new measurement reporting to all the connected mode UEs at the time of taking the decision to enable network energy saving feature. However, this would require the network node to send the reporting configurations to all the UEs at a moment of need, and thus again lead to increased processing overhead and more over-the-air resource usage overhead.

In a second example or scenario, the load in a network node could increase because of additional UEs coming into the network node or via change in the traffic patterns amongst the UEs that are already connected to the network node. When the load in the cell increase quickly due to the change in the traffic pattern of users, then it may become necessary to enable inter-frequency mobility load balancing functionality so that the network node can move certain UEs to different neighboring cells.

When a network node decides to enable such an inter-frequency mobility load balancing feature, it would like to gracefully handover few of those UEs to the neighboring cells whose data traffic expectations can be met in the neighbor cells. In such a case, the network node needs to know which UE could be served with which other neighboring cell (intra frequency and/or inter-frequency) so that it can initiate a handover procedure. However, none of the connected UEs might have sent a measurement report using which a handover procedure can be initiated as the measurement report triggering conditions configured for the handover might not have been met.

As before, in order overcome this issue, the network node can configure periodical reporting so that it can get to know the radio quality as experienced by the UE on different frequencies at a regular interval so that it can always readily take any action based on these reports. However, as before, the periodical reporting is a large overhead for the UEs and on the network in terms of processing overhead and also the over-the-air resource usage.

Similar as before, another way to circumvent the issue would be for the network node to configure new measurement reporting to all the connected mode UEs at the time of taking the decision to perform inter-frequency load balancing. However, this would require the network node to send the reporting configurations to all the UEs at a moment of need and thus again leading to processing overhead and over-the-air resource usage overhead. Further, this also increases the inter-node communication overhead e.g., the Centralized Unit (CU) may need to inform the Distributed Unit (DU) about the measurement reports so that the DU can select the UEs that are best to be handed over to the inter-frequency candidates (since the DU has more and/or better information about the load situation, the selection of which UEs that needs to be handed over to best reduce/balance the load is therefore preferably performed by the DU).

Further, the continued work to define the next generation 6G radio access network standard has started. It is too early to know exactly how 6G will look like once finalized, but one thing that is up for discussion is to introduce a stricter separation between active mode functions (e.g. data transfer, active mode positioning and sensing, etc.) and idle mode functions (e.g. initial cell search, initial system time and frequency synchronization, reception of system information, random access, paging, etc.). In such cases it may be desirable to obtain measurements related to a potential idle mode performance when the device is in connected mode. This can e.g. be enabled by, in accordance with the embodiments disclosed here, preconfigure a set of measurements corresponding to an expected idle mode performance (e.g. using only signals that will be available for idle mode UEs) and a set of connected mode measurements (e.g. using only signals that are additionally configured and provided to connected mode UEs). For example, in some situations it may be important to verify that idle mode coverage is potentially available in case the current connected mode data beam would stop working.

Therefore, some embodiments herein propose a measurement framework where a set of measurement configurations may be sent to the UE, or a group of UEs, in advance. Further, an indication may be sent to the UE to indicate the request for transmission of a measurement report (either using a lower layer signaling (e.g., MAC CE or DCI signaling) or via RRC signaling based on a measurement configuration that is part of the set of measurement configurations sent earlier.

However, in some embodiments, the indication may comprise an instruction to perform a measurement based on a measurement configuration that is part of the set of (latent) measurement configurations sent earlier, whereupon the UE may be configured to perform the measurement and in response to a measurement result of the measurement fulfilling a measurement condition/criterion, initiate a handover to a different network node other than the currently serving network node (e.g., by transmitting a PRACH signal to the different network node). In such cases, the transmitted PRACH to the different network node may be construed as a one-bit quantification/quantization of a measurement report.

### Embodiments

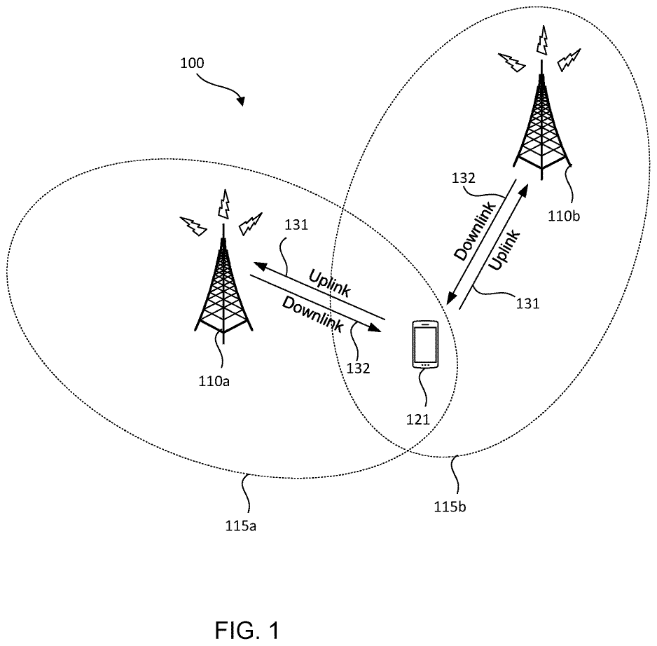

FIG. 1 depicts a wireless communications network 100 in which embodiments herein may operate. In some embodiments, the wireless communications network 100 may be a radio communications network, such as, 5G or NR network. Although, the wireless communications network 100 is exemplified herein as an 5G or NR network, the wireless communications network 100 may also employ technology of any one of LTE, LTE-Advanced, WCDMA, GSM/EDGE, WiMax, UMB, GSM, or any other similar network or system. The wireless communications network 100 may also employ technology of an Ultra Dense Network, UDN, which e.g. may transmit on millimetre-waves (mmW).

The wireless communications network 100 comprises a first network node 110a and a second network node 112b. The first network node 110a may serve wireless devices in at least one cell 115a, or coverage area and the second network node 110b may serve wireless devices in at least one cell 115b, or coverage area. The network nodes 110a, 110b may correspond to any type of network node or radio network node capable of communicating with a wireless device and/or with another network node, such as, a base station (BS), a radio base station, gNB, eNB, eNodeB, a Home NodeB, a Home eNodeB, a femto Base Station (BS), or a pico BS in the wireless communications network 100. Further examples of the network node 110 may be a repeater, multi-standard radio (MSR) radio node such as MSR BS, network controller, radio network controller (RNC), base station controller (BSC), relay, donor node controlling relay, base transceiver station (BTS), access point (AP), transmission points, transmission nodes, a Remote Radio Unit (RRU), a Remote Radio Head (RRH), nodes in distributed antenna system (DAS), or core network node. In some embodiments, the two network nodes 110a, 110b are separate entities of the same gNB, such as e.g. a CU and a DU.

In FIG. 1, the wireless device 121 is served by the first network node 110a in the cell 115a of the first network node. The wireless device 121 is configured to communicate within the wireless communications network 100 via the first network node 110a over a radio link served by the first network node 110a. Utilizing the radio link, a bi-directional communications flow may be set up between the wireless device 121 and any entity capable of communication via the wireless communications network 100. The wireless device 121 may transmit data over an air or radio interface to the first network node 110a in uplink, UL, transmissions 131 and the radio base station may transmit data over an air or radio interface to the wireless devices 121 in downlink, DL, transmissions 132. The wireless devices 121 may refer to any type of wireless devices (WDs) or User Equipments (UEs) communicating with a network node and/or with another wireless device in a cellular, mobile or radio communication network or system.

However, the wireless device 121 is within the coverage area of the second network node's cell 115b. Thus, in some embodiments, the first network node 110a may transmit to the wireless device 121, a signal comprising an indication of a request for one or more measurement reports. Here, the one or more measurement reports are associated with one or more (corresponding) measurement configurations of the wireless device 121. The first network node 110a, may then receive the one or more measurement reports from the wireless device 121 in accordance with the transmitted indication, and initiate a handover procedure to handover the wireless device 121 to the second network node 110b. Thus, upon handover of the wireless device 121 from the first network node 110a to the second network node 110b, the wireless device would be served by the second network node 110b in the cell 115b. At the same time, upon completing the handover, the first network node 110a may perform a network energy saving function based on the received one or more measurement reports. It should be noted that in some embodiments, the indication of a request for one or more measurement reports is transmitted from the second network node 110b and the measurement reports may also be received by the second network node 110b.

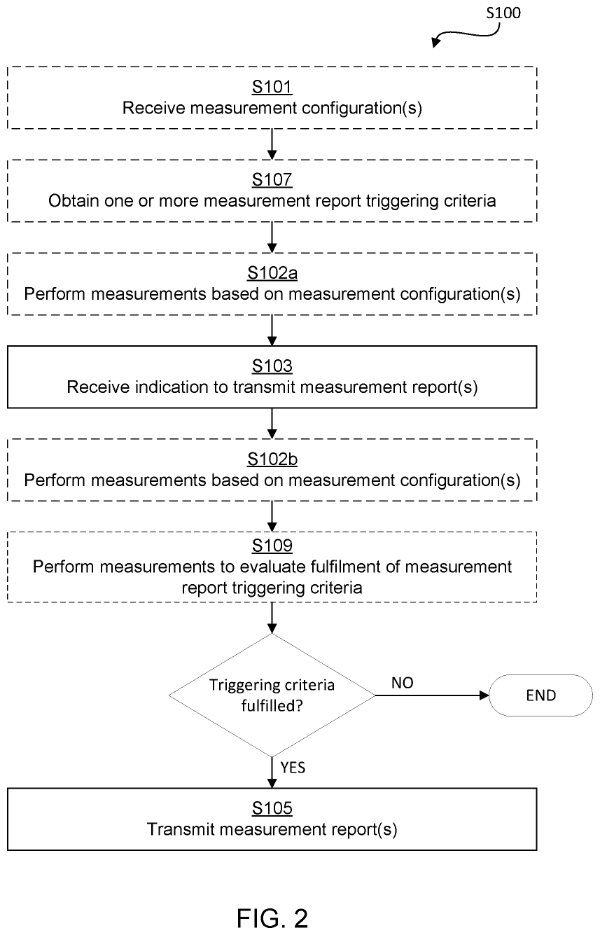

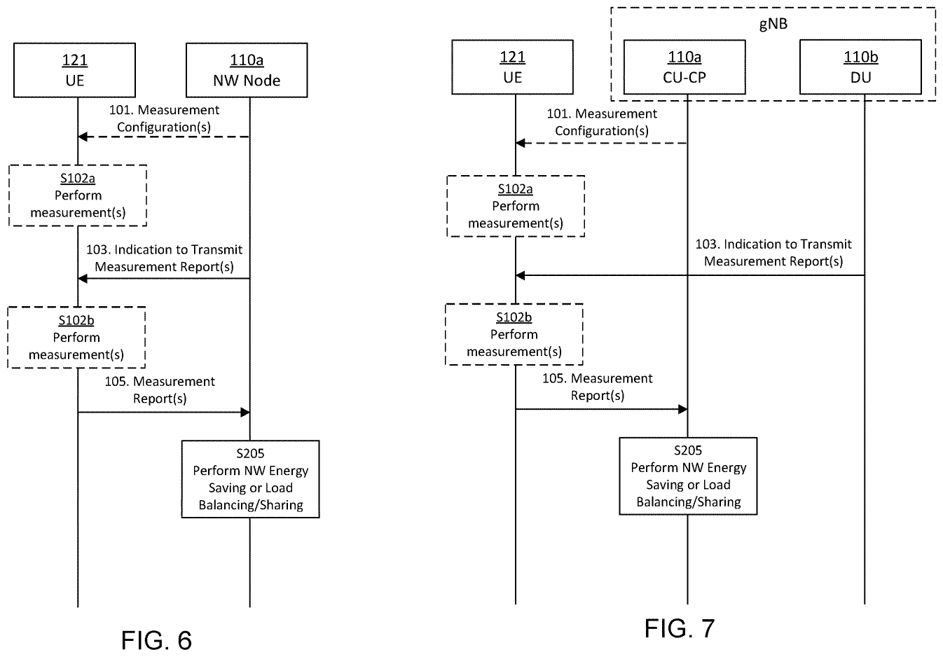

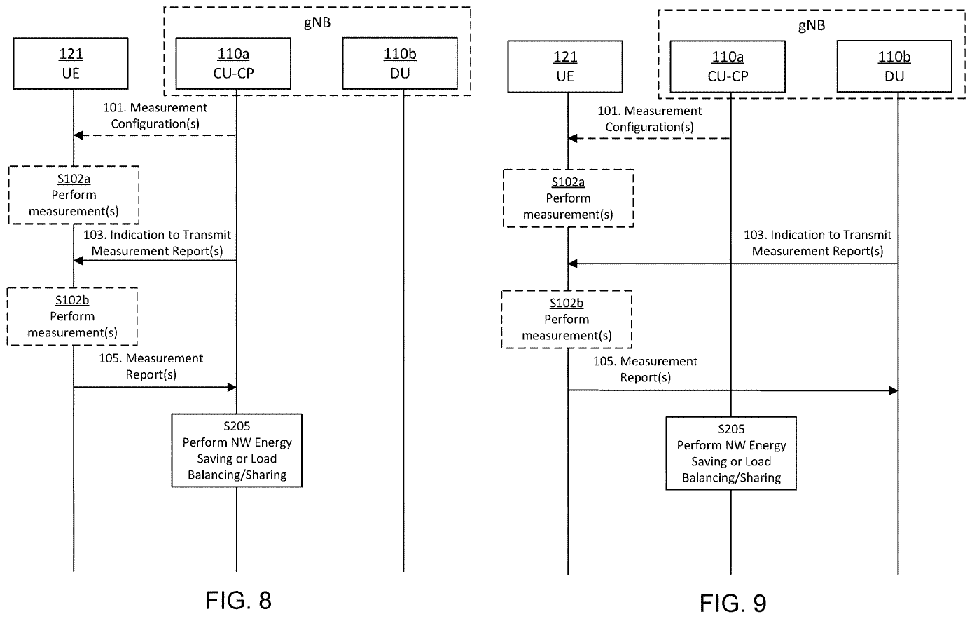

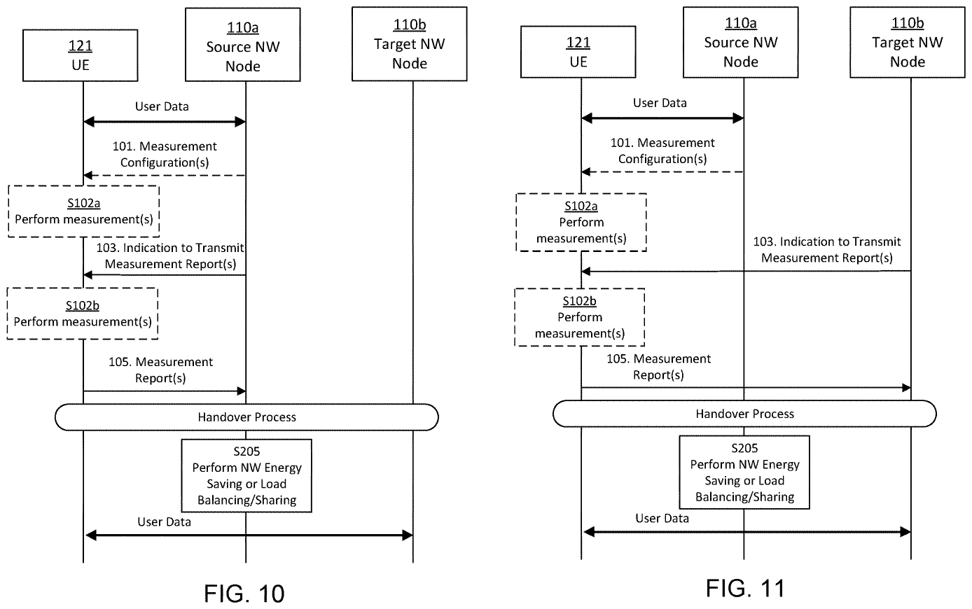

Turning to FIG. 2, which is a schematic flowchart representation of a method S100 performed by a UE 121 in a wireless communication network in accordance with some embodiments. In particular, the method S100 provides for a dynamic measurement reporting for wireless communication systems in order to better utilize network energy saving functionality. The following description will be made in reference to FIG. 2 as well as the schematic signaling diagrams depicted in FIGS. 6-11.

In some embodiments, the method S100 comprises receiving S103 a signal comprising an indication 103 to transmit one or more measurement reports from a first network node 110a or a second network node 110b. Each measurement report is associated with a measurement configuration out of one or more measurement configurations. The method further comprises transmitting S105 the one or more measurement reports 105 to the first network node 110a or to the second network node 110b. It is to be understood that, in the present context, one example of the transmitted “measurement report” may be “a signal that is transmitted based on a performed measurement”.

In more detail, a “measurement report” may be both implicit and explicit. Moreover, the measurement reports may be detailed or very coarsely quantified or quantized. For example, the UE may be configured to perform a measurement with an associated instruction (e.g., indicted in the corresponding measurement configuration) to send an explicit report containing a value/signal representing the measurement to the network node in case it is higher than a threshold, then implicitly the UE will communicate that the measurement is below said threshold if it does not send the explicit report. Thus, this absence of an explicit measurement report may be understood, by the network, as an implicit measurement report. The same amount of information (1 bit) is received by this implicit measurement report (“the value is below a threshold”) as when the UE sends a message explicitly indicating that “the measurement was above a threshold”. Hence, if the actual measurement value is unimportant, then the UE can send any signal (e.g. like a PRACH transmission or an SRS transmission) to report that the measurement is above a threshold. This can be seen as a 1-bit quantization of the measurement report using an on-off signaling format. The rules (e.g., indicated in the measurement configuration) for the UE may for example be “If the measurement is below a threshold, then send nothing” (representing an implicit 1 bit measurement reporting using the off-part of the on-off-signaling) and “if the measurement is above a threshold, then send a PRACH signal, SRS signal, or any other suitable signal” (representing an explicit 1 bit measurement report using the on-part of the on-off signaling).

For example, the UE may transmit S105 a signal as part of a handover process, where this signal is transmitted in response to one or more measurement criteria being fulfilled. Thus, the UE may receive S103 the signal, and perform one or more measurements in response thereto, but the measurement results aren't necessarily explicitly transmitted, instead the UE may transmit a PRACH signal to the target node. Similar as before, the source node is enabled to perform a network energy saving function and/or mobility load balancing/sharing.

In some embodiments, the method further comprises receiving S101 the one or more measurement configurations 101 from the first network node 110a or the second network node 110b. The one or more measurement configurations 101 may be received in a measurement configuration framework. For example, the one or more measurement configurations 101 may be received in a Radio Resource Control, RRC, measurement configuration framework, such as e.g. in a MeasConfig Information Element (IE).

In some embodiments, the UE 121 receives S101 the one or more measurement configurations 101 from the first network node 110a or the second network node 110b via a dedicated RRC message, e.g., RRC signaling, or RRC release. In some embodiments, the UE 121 receives S101 the one or more measurement configurations 101 from the first network node 110a or the second network node 110b via a broadcasted message, e.g., a System Information Block (SIB) or a dedicated SIB, e.g., an energy saving SIB.

In some embodiments, the one or more measurement configurations 101 is/are indicated in a MeasConfig Information Element. Accordingly, the MeasConfig Information Element may comprise a corresponding Identification element, MeasID, for identifying each of the one or more measurement configurations 101, and the received S103 indication to transmit the one or more measurement reports 105 comprises one or more ID elements identifying the one or more measurement configurations 101 associated with the one or more measurement reports 105.

In some embodiments, the received S101 one or more measurement configurations 101 include an indication that indicates to the UE 121 that this/these measurement configuration is/are associated to a measurement reporting which is triggered based on a further indication from a network node. In other words, the received S101 measurement configuration(s) may be understood as “latent” measurement configurations which may be triggered by the received S103 signal (i.e. by the indication to transmit one or more measurement reports).

In some embodiments, the one or more measurement configurations 101 include an indication that indicates to the UE 121 the resources over which the UE 121 can transmit S105 the measurement reports. However, the resources over which the UE 121 can transmit S105 the measurement reports may alternatively be indicated as part of the indication 103 to transmit the one or more measurement reports, or they may be otherwise preconfigured by the NW.

In some embodiments, the one or more measurement configurations 101 include an indication that indicates to the UE 121 to which node, e.g., first or second network node it should transmit S105 the measurement reports 105. The first network node and second network nodes may for example be two separate radio base stations, or a Centralized Unit (CU) and a Distributed Unit (DU) of the same radio base station (see e.g. FIGS. 7-9).

Further, in some embodiments, the method S100 further comprises performing S102a, S102b measurements in accordance with the one or more measurement configurations 101 that is/are associated with the indicated one or more measurement reports in order to generate the one or more measurement reports. The measurements may be performed S102b in response to receiving S103 signal comprising the indication to transmit the measurement report(s). Alternatively, the measurements may be performed S102a prior to receiving the signal comprising the indication to transmit the measurement report(s). Accordingly, the UE 121 may initiate performing S102a the measurements immediately upon receiving S101 the measurement configuration 101 from the first network node 110a or the second network node 110b. This aids to ensure that the UE always has the relevant information available in its memory to send a measurement report or to evaluate a triggering condition if the network sends an indication 103 to do so.

Alternatively, the UE 121 may initiate the performing S102b of the measurements only upon receiving the further indication 103 that indicates the network node's interest in the measurement report 105. This aids to ensure that the UE 121 does not perform measurements unnecessarily all the time and also this aids to ensure that the measurement gaps are provisioned only when the associated inter-frequency measurements are necessary for the network.

Accordingly, in some embodiments, the received S103 signal may be construed as a trigger for the UE 121 to perform S102b one or more measurement according to the one or more measurement configurations. Thus, the method S100 may comprise receiving a signal, from a first (source) network node 110a, comprising an indication to perform one or more measurements associated with a measurement configuration out of one or more measurement configurations. As mentioned, these measurement configurations may be “latent” measurement configurations. Then, in response to receiving S103 the signal comprising the indication to perform one or more measurements, the method S100 may comprise performing S102b a measurement in accordance with the one or more measurement configurations indicated by the received S103 signal. Then, the method S100 may comprise transmitting a PRACH signal to a second (target) network node 110b (e.g., in order to be served by the target network node 110b). As before, the first network node 110a may then perform S205 a network energy saving function and/or load balancing/sharing. Here, the PRACH signal is considered to be a very coarsely quantized measurement report, indicating that the measurement result fulfilled some condition or criterion (e.g., was above some measurement value).

Still further, in some embodiments, the method S100 comprises obtaining S107 one or more measurement report triggering criteria for each measurement report of the one or more measurement reports. Thus, in some embodiments, the transmitting S105 the measurement report is performed in response to the obtained S107 one or more measurement report triggering criteria being fulfilled.

Accordingly, upon the one or more measurement report triggering criteria being met, the UE 121 transmits S105 the measurement report and includes the measurements as configured and/or indicated, in accordance with some embodiments. The resources over which the UE 121 transmits the measurement reports may be configured by the NW or based on pre-configuration. For example, as part of the indication, the UE may receive the resources over which to transmit the report, e.g., as part of the DCI indication, or if the UE receives the MAC CE indication it automatically enables the resources that the UE needs to transmit the report with them.

In some embodiments, the one or more measurement configurations 101 include an indication that indicates to the UE 121 that this/these measurement configuration(s) is/are associated to a measurement reporting evaluation which is triggered based on a further indication from a network node, i.e. based on the received S103 signal. In other words, the one or more measurement report triggering criteria may be indicated in the associated one or more measurement configurations 101. The one or one or more measurement report triggering criteria may be indicated in an RRC measurement configuration framework, such as e.g. in a MeasConfig Information Element.

Accordingly, the existing RRC measurement configuration framework may be used for configuring the measurement report triggering criteria. For example, MeasConfig may be extended with a new information element (e.g., a Boolean or alike called LatentUntilTriggered, or ActivatedBySubsequentTriggers or similar). Through such an extension, if the new information element is set to true, the UE 121 knows that unlike other measurement configurations, this measurement configuration is latent (not immediately activated). The measurement is activated first if the indication is received S103 by the UE 121, and optionally if the measurement report triggering criteria are detected by the UE 121. Furthermore, in said existing measurement existing configuration framework, each configuration is distinguished through an identity. In some embodiments, the UE 121 may be configured with one or more “latent” measurement configurations. Then the NW trigger/indicator may address one or more of the configurations by further indicating the identity/identities of the configuration(s). The MeasId may be carried by indicators, such as, Downlink Control Information (DCI), Medium Access Control (MAC) Control Element (CE), or Radio Resource Control (RRC) message.

Accordingly, the measurement configuration(s) may be dependent on a specific traffic-related criteria. For example, the measurement configuration may be triggered upon an indication from the NW in case the UE 121 is also involved in a certain service/traffic flow of a specific Quality of Service (QoS) or 5G QoS Identifier (5QI). Another example could be if the UE 121 is currently also involved in a service with data exchange in one or more directions (UL/DL) which in average over a specified time is exceeding a certain threshold. Yet another example could be if also the UE 121's current/foreseen UL buffer is above a certain threshold. The UE 121 may be additionally configured with a set of resources over which it can perform the report which those resources become available as soon as the UE 121 reports a Buffer Status Report (BSR) larger than a first threshold. A similar approach can be followed in DL, e.g., if the UE 121 is configured with a DL buffer report, such that either the UE 121 reports to the gNB of its expected DL buffer, or that the gNB tells the UE 121 about the current DL buffer, if any of these reports or similar ones are above a second threshold (which may also be configured or pre-configured for the UE 121), then the UE 121 is expected to provide the measurement reports.

In some embodiments, the UE 121 may be configured to automatically/implicitly trigger the measurement upon traffic-related criteria being fulfilled without awaiting a triggering indication from the NW. E.g., the UE 121 may be configured with a condition to trigger the report automatically if the traffic conditions in UL satisfies a specific criterion, e.g. the UE 121 may report BSR to be larger than a first threshold, where the first threshold is configured for the UE 121 such that if the BSR is larger than that, then the UE 121 should report the measurements. In other words, the transmission S105 of a measurement report need not be preceded by a received indication S103, but may instead depend on a traffic-related criteria being fulfilled.

In accordance with some embodiments, the one or more measurement report triggering criteria comprises at least one of:
Reference Signal Received power (RSRP) of the first node is lower than a corresponding threshold.
Reference Signal Received power (RSRP) of the second node is higher than a corresponding threshold.
Reference Signal Received Quality (RSRQ), of the first node is lower than a corresponding threshold.
Reference Signal Received Quality (RSRQ) of the second node is higher than a corresponding threshold.
Signal to Interference plus Noise Ratio (SINR) of the first node is lower than a corresponding threshold.
Signal to Interference plus Noise Ratio (SINR) of the second node is higher than a corresponding threshold.
Uplink, UL, buffer data size is above a corresponding threshold.
UL buffer data size is below a corresponding threshold.
An inactivity timer of the wireless device 121 is above a corresponding threshold.
An inactivity timer of the wireless device 121 is below a corresponding threshold.
That a specific service or type of service is currently running or is currently not running.
That a specific slice is currently active.
That a mobility state of the wireless device 121 is at one state out of a plurality of predefined states.
   The mobility states may for example include high speed, medium speed, or low speed.

For example, the one or more measurement configurations 101 may entail specific measurement report triggering criteria that relate to channel-quality. In more detail, the measurement reporting may be triggered if the RSRP or RSRQ or SINR of the second network node 110b is higher than a first threshold, and/or RSRP or RSRQ or SINR of a first network node 110a is below a first threshold. However, in some embodiments, the one or more measurement report triggering criteria include that the UE 121 has specific service/slice currently running. For example, UEs 121 that have URLLC related slice (based on NSSAI indication) may be considered to correspond to UEs 121 that have a specific slice running. Moreover, the one or more measurement report triggering criteria may be based on an inactivity timer of a UE 121 (the timer that indicates the time since the last data transmission or reception at the UE 121). For example if inactivity timer is below or above a threshold.

In some embodiments, the method S100 further comprises performing S109 measurements in order to evaluate a fulfilment of the one or more measurement report triggering criteria. Moreover, the performance S109 of the measurements in order to evaluate a fulfilment of the one or more measurement report triggering criteria may be executed in response to receiving S103 the signal comprising the indication to transmit one or more measurement reports.

In some embodiments, the one or more measurement configurations 101 include an indication that indicates what type of triggering would be used to trigger the measurement report at a later point in time. For example, the configuration could include whether the triggering is based on an RRC message or based on a MAC Control Element (CE) or based on a Downlink Control Information (DCI) or based on the reception of a reference signal or another type of sequence from the network node.

In some embodiments, the one or more measurement configurations 101 comprise an indication that indicates the implicit trigger for measurement reporting, e.g., if the UE 121 is configured with a Frequency Range 2 (FR2) Secondary Cell (SCell) and that SCell is activated, then the UE 121 should perform the configured measurement reporting, or alternatively, if a SCell is deactivated or deconfigured the UE 121 should perform the configured reporting. The implicit trigger can also be based on a UE 121 initiation, e.g., if the UE 121 requests an on-demand SSB or CSI-RS, then it should transmit the configured measurement reports.

In some embodiments, the wireless device 121 may be associated with a group of wireless device 121s out of a plurality of groups of wireless device 121s, where each group has a corresponding group identification, ID, and the received S103 signal further comprises an indication of a specific group ID. Accordingly, the method S100 may further comprise checking if the specific group ID corresponds to the group ID that the wireless device 121 is associated to. Then, in response to the group ID of the wireless device 121 corresponding to the specific group ID, the method S100 may further comprise transmitting the one or more measurement reports to the first network node or to the second network node. Similarly, the wireless device 121 may be associated to a certain type of wireless device 121s (e.g. URLLC devices), and the corresponding steps may be applied for a “type ID” as an alternative or addition to the aforementioned “group ID”. Similarly, the performance S109 of the measurements in order to evaluate a fulfilment of the one or more measurement report triggering criteria may be executed in response to receiving S103 the signal comprising the indication to transmit one or more measurement reports and further in response to the group ID of the wireless device 121 corresponding to the specific group ID.

In other words, the UEs 121 may be configured to belong to a certain group. Later indications/triggers from the NW may address one or more groups. Only those addressed UEs 121 will then trigger the measurement reporting and/or measurement execution/performance. The indicators may either carry the group identity of the UE 121 within the indication message (e.g., DCI, MAC-CE, or RRC message) as an explicit information element, or the indicator may be encoded through a specific Radio Network Temporary Identifier (RNTI) known to the specific group of UEs 121, or the indicator may be provided over time/frequency resources specific to the group of UEs 121. Through such mechanism, the NW may trigger a subset of UEs 121 at a time to trigger the measurement report and thereby avoid a heavy storm of UL measurement reports. Alternatively, or additionally, the NW may at the point in time only be interested in receiving a report from a specific type of UEs 121 (e.g., Ultra Reliable Low Latency Communication (URLLC) UEs 121, Machine Type Communication (MTC) UEs 121, IoT UEs 121, etc.).

In some embodiments, the UE 121 only performs S102a, S102 the measurements associated with the one or more measurement configurations 101 if it belongs to the specific group addressed by indicator 103 from the NW.

Further, in some embodiments, the one or more measurement configurations 101 include an indication that indicates a measurement report purpose. For example, a measurement configuration could include whether the measurement report is expected to be used for network energy saving purpose or for inter/intra-frequency load balancing purpose or any another network use case. For example, some measurement configurations could indicate to the UE 121 to include RSRP and RSRQ of the serving cell and neighbor cells when the measurement report is triggered for the purpose of load balancing. Additionally, or alternatively, some measurement configurations could indicate to the UE 121 to include only RSRP and RSRQ of the neighbor cells when the measurement report is triggered for the purpose of network energy saving.

In some embodiments, the one or more measurement configurations 101 include an indication that indicates the one or more measurement report triggering criteria from which the UE 121 could be asked to use one or more to evaluate whether to send the measurement report or not upon receiving a further indication (i.e. upon receiving S103 the signal). For example, the configuration could indicate to the UE 121 to use FR1 based measurements or FR2 based measurements to evaluate the one or more measurement report triggering criteria. For example, the configuration could indicate to the UE 121 to use RSRP of the serving cell or RSRQ of the serving cell to evaluate the one or more measurement report triggering criteria. The one or more measurement configurations 101 could further indicate whether to use different thresholds to evaluate the one or more measurement report triggering criteria.

In some embodiments, the one or more measurement configurations 101 include an indication that indicates what measurements are to be included in the measurement report when the UE 121 sends the corresponding measurement reports. This configuration could be provided per report triggering method used (i.e., RRC message based trigger, based on a MAC CE, based on a DCI, or based on the reception of a reference signal from the network node as mentioned earlier). For example, the one or more measurement configurations 101 could indicate to the UE 121 to include RSRP and RSRQ of the serving cell and neighbor cells when the measurement report is triggered based on a further RRC message and/or the configuration could indicate to the UE 121 to include only RSRP and RSRQ of the neighbor cells when the measurement report is triggered based on a further MAC message. Additionally, the indication may indicate if the measurements should be performed over all the configured resources of a second node, e.g., SSBs, or a subset of them.

The one or more measurement configurations 101 may further contain a timer related threshold information. In some embodiments, the timer indicates to the UE 121, for how long does the UE 121 needs to perform the measurements S109 to evaluate the fulfilment of the measurement report triggering criteria after receiving the indication (i.e. after receiving S103 the signal).

In more detail, in some embodiments, the UE 121 is configured to start a timer at the moment of receiving S103 the indication from the first or the second network node and if the one or more measurement report triggering criteria have not been met until the timer reaches the threshold value as configured in the measurement configuration, then from that point in time onwards the UE 121 stops evaluating the one or more measurement report triggering criteria.

In some embodiments, the NW uses an indicator to stop the UEs 121 from further reporting, i.e. from transmitting further measurement reports. For example, the measurement configurations that were earlier triggered may be of periodic nature and after a certain number of reports, the NW might not be interested in receiving further reports. UE 121 receiving such indicator refrains from providing further reports until further triggers are received.

The “stop”-indicator may either be a separate indicator (separate DCI, MAC-CE, RRC message) from the triggering indicator, i.e. the “stop”-indicator may be received as a separate signal. However, in some embodiments, there is one single indicator in this carrying a start/stop information element. Similar as above cases, the “stop”-indication may address specific groups and/or measurement identities and thereby stop further reporting for those specific groups of UEs 121 or specific configurations identified via MeasId.

In some embodiments, the received signal S103 is an RRC signal. The received S103 signal may further comprise the one or more measurement configurations 101 associated with the one or more measurement reports. In other words, the network node may be configured to provide the necessary measurement configurations together with the indication to transmit the one or more measurement reports. However, in some embodiments, the received S103 signal is a physical layer signal or a Medium Access Control (MAC) signal, i.e. an L1 or L2 signal.

Accordingly, in some embodiments, the UE receives an indication 103 from a first network node 110a or second network node 110b to transmit S105 a measurement report 105 associated to a previously configured measurement configuration. In some embodiments, the first network node is a CU-CP node (as indicated in FIGS. 7-9) and the corresponding indication is received via an RRC message. In some embodiments, the second network node is a DU node (as indicated in FIG. 7-9) and the corresponding indication is received via a L1 or L2 signaling (a DCI signal, a reference signal, or MAC CE). In some embodiments, the indication 103 to transmit the measurement report maybe received from another node, e.g., the first node 110a, even though the measurements are performed over the second node 110b reference signals.

Accordingly, the received S103 signal may comprise an indication in the form of a MAC Control Element CE or a MAC Protocol Data Unit (PDU) containing concatenated MAC CEs. Such a MAC CE may contain information regarding which particular measurement configuration related measurement report is to be transmitted S105 to the first or second network node. In some embodiments, the MAC CE indication contains one or more of the MeasId Information Elements.

In some embodiments, the MAC CE contains information whether the measurement configuration shall start or stop. In some other embodiments, different MAC CEs are used for starting or stopping the measurement configurations. In some embodiments, the MAC CE contains one or more UE 121 group identities. Thereby enabling the network node to address specific UEs 121 or specific groups/types of UEs 121.

Furthermore, the MAC CE may instead address all UEs 121 of the cell. Such a MAC CE could also contain information regarding which measurement report triggering criterion needs to be evaluated. For example, the MAC CE could indicate the UE 121 to trigger the measurement report only if the measurement on a cell in neighbor frequency is above a certain threshold. The MAC CE could indicate this triggering method via pointing to an index in the configuration that configures the triggering criterion.

Such a MAC CE could also contain information regarding which measurement report contents need to be included in the measurement report. For example, the MAC CE could indicate that the UE 121 should report the measurements on Frequency-1 and Frequency-2 in the measurement report.

An example of a MAC CE in accordance with some embodiments is given below.

| | | | | | | | | |
|---|---|---|---|---|---|---|---|---|
| #0 | #1 | #2 | #3 | #4 | #5 | #6 | #7 | Bit number |

| | | | |
|---|---|---|---|
| Freq ID | Trigger ID | Report Content ID | OCT1 |

In this example embodiment, the MAC CE contains three fields. The first field being Freq ID and this indicates the frequency associated to which the measurement report is to be triggered (or triggering evaluation is to carry out). In the example, there can be up to 8 different values that can be indicated using the field Freq ID. Exactly what each value corresponds to could be configured in the associated measurement configuration. For example, “000” may correspond to that only FR1 related measurements are of interest, “001” may correspond to that only FR2 related measurements are of interest, “010” may corresponds to that FR1 and FR2 related measurements are of interest, etc.

The second field is Trigger ID and this indicates the triggering criterion to be carried out to decide whether to send a measurement report. In the example, there can be up to 4 different values that can be indicated using the field Trigger ID. Exactly what each value corresponds to could be configured in the associated measurement configuration. For example, “00” may correspond to indicating to the UE 121 to transmit the measurement report without any further trigger evaluation (sort of one shot reporting), “01” may correspond to indicating to the UE 121 to transmit the measurement report only if the RSRP measurement quantity of a cell is above a first threshold, “10” may correspond to indicating to the UE 121 to transmit the measurement report only if the RSRQ measurement quantity of a cell is above a second threshold, and “11” could correspond to indicating the UE 121 to transmit the measurement report only if the RSRP measurement quantity of a cell is above the first threshold and the RSRQ measurement quantity of the same cell is above the second threshold.

The third field is Report Content ID and this indicates the report contents that needs to be included in the measurement report. In the example, there can be up to 8 different values that can be indicates using the field Trigger ID. Exactly what each value corresponds to could be configured in the associated measurement configuration. For example, “000” may correspond to indicating to the UE 121 to include all available RSRP measurements of the serving cells only, “001” could correspond to indicating to the UE 121 to include all available RSRP measurements of the neighboring cells only, and “010” could correspond to indicating to the UE 121 to include all available RSRP and RSRQ measurements of the serving cells and the neighbor cells.

An example configuration that enables such MAC CE is given below. In the example, the freqIDListConifg would include frequency-1 related measurement Object ID as the first entry followed by frequency-2 related measurement Object ID as the second entry followed by frequency-1 and frequency-2 related measurement Object IDs as the third entry. In the example, the triggerIDListConifg would indicate the mandatory reporting followed by RSRP measurement quantity being above Threshold-1 so on.

| | |
|---|---|
| NewMeasConfig ::= | SEQUENCE { |
| freqIDListConfig | SEQUENCE (SIZE (1..8)) OF MeasObjectConfigId |
| triggerIDListConfig | SEQUENCE (SIZE (1..4)) OF TriggerConfigID |
| reportIDListConfig | SEQUENCE (SIZE (1..8)) OF ReportContentID |

}
MeasObjectConfigId ::= SEQUENCE (SIZE (1..N)) OF MeasObjectId
TriggerConfigId ::= SEQUENCE (SIZE (1..N)) ReportConfigID
ReportContentID ::= SEQUENCE (SIZE (1..N)) ReportConfigID

In the above example, an indexing-based MAC CE approach is mentioned. However, in some embodiments a bit map-based approach is used. In some embodiments, the indicator 103 (i.e. the received S103 signal) may comprise a bitmap or a codepoint within a DCI or MAC Control Element (CE) message. In reference to the bitmap, e.g., each bit may indicate which UE 121 or group of UEs 121 should provide the report. Additionally, another bitfield or a continuation in the same bitfield may be used to indicate, to the UE 121, the specific measurements which it needs to provide, e.g., measurements of RSs received from a second node. In reference to the codepoint approach, the codepoint can refer to the UE 121 or group of UEs 121 which should provide the report, or additionally also indicate what measurements should be reported. In some embodiments, the received S103 signal comprises a bitmap and/or codepoint indicating the request to transmit one or more measurement reports, the type of measurements that needs to be performed, a group ID of the UE 121, a type ID of the UE 121.

An example implementation of the bit map-based approach is given below. In this example, there is a fixed mapping between the bit positions within an OCTET of a MAC CE with a value as configured by the associated measurement configuration.

| #0 | #1 | #2 | #3 | #4 | #5 | #6 | #7 | Bit number |
|---|---|---|---|---|---|---|---|---|
| Freq1 | Freq2 | Freq1 and | Spare | Spare | Spare | Spare | Spare | OCT1 |
| | | Freq2 | | | | | | |
| Send | RSRP > | RSRQ > | RSRP > Threshold1 | Spare | Spare | Spare | Spare | OCT2 |
| Always | Threshold1 | Threshold2 | AND | | | | | |
| | | | RSRQ > Threhsold2 | | | | | |
| RSRP | RSRP of | RSRP and | | | | | | OCT3 |
| of | neighbor | RSRQ of | | | | | | |
| serving | cells | serving and | | | | | | |
| cells | | neighbor | | | | | | |
| | | cells | | | | | | |

In this bit map-based example, the position of the bits in each OCTET of the MAC CE indicates the corresponding values. In short, the positions of the bits in OCT1 indicate the frequency associated to which the measurement report is to be triggered, i.e. the frequency/frequencies that are to be used for performing S109 measurements to evaluate fulfilment of measurement report triggering criteria. The positions of the bits in OCT2 indicate the one or more measurement report triggering criteria, while the positions of the bits in OCT3 indicate the report contents that need to be included in the transmitted S105 report. What bit corresponds to what value may be pre-configured via the measurement configuration(s). In the above examples, the measurement report triggering criteria are based on measurement quantities like RSRP and RSRQ. However, the measurement report triggering criteria configuration could also include other measurements or metrics as already exemplified in the foregoing.

Moreover, the bit map may include another octet where the positions of the bits indicate a specific group of UEs 121 and/or a specific type of UEs 121 (e.g. URLLC UEs 121).

In some embodiments, the indication 103 is a L1 based signal, e.g., a DCI. In some embodiments, the L1 based indication is a reference signal (RS), or another type of sequence transmission from the network node 110a, 110b.

In some embodiments, the DCI is associated with a specific RNTI for distinguishing a specific group of UEs, or the specific measurement reporting activity, e.g., an M-RNTI. In some embodiments, the DCI is provided in time and/or frequency resources specific for a group of UEs.

In some embodiments, the DCI can only be configured with a common search space if the DCI is group common, or with a UE specific search space, of the DCI is a UE specific DCI, e.g., a DCI associated with a C-RNTI, e.g., DCI 0-1, 1-1, 0-2, or 2-0. In some embodiments, the one or more UE group identities reside in the DCI e.g., as bitmap or codepoint.

In some embodiments, the MeasId resides in the DCI. For example, 6 bits may be used in the DCI to address one of the 64 MeasIds at a time. Alternately, the measurement framework as disclosed herein may allow only for a few measurement configurations (e.g., with MeasId 1 . . . 4), and the bits in DCI act as a bitmap that may trigger more than one MeasId (e.g., 4 bits, where each set bit triggers one of 4 measurement configurations).

In some embodiments, the DCI indirectly addresses a MeasId through MAC CEs or RRC messages. For example, a MAC CE (or and RRC message) may first be used for pointing out a sub-set of MeasIds (e.g., MAC CE that points out MeasIds 10, 11, 24, 64). Then the activation bits in DCI are indices to the MeasIds pointed out.

In some embodiments, the start/stop command resides in the DCI whereas in another embodiment different DCIs or DCIs encoded with different RNTIs are used for start/stop of the measurements.

In some embodiments, the indication 103 received from the first or second network node is an indication to perform at least one of the preconfigured measurements in the received S101 set of measurement configurations 101. In other words, the indication to transmit one or more measurement reports is implicit in the indication to perform at least one of the preconfigured measurements. The UE 121 then transmits S105 one or more measurement reports 105 containing the at least one measurement to the first network node or the second network node.

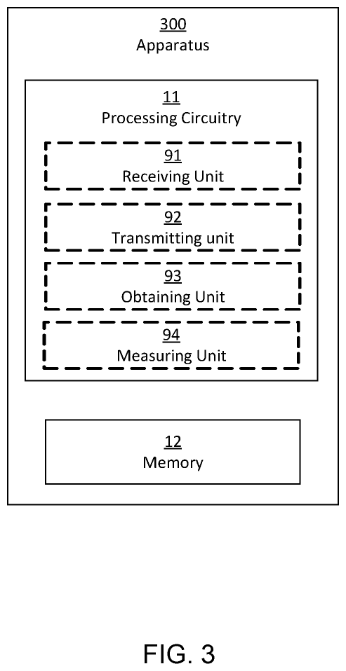

FIG. 3 is a schematic block diagram representation of embodiments of an apparatus 300 in a wireless communication network 100 (for example, the wireless network shown in FIG. 1). The apparatus 300 may be implemented in a wireless device (e.g. the wireless device 121 shown in FIG. 1). The apparatus 300 is operable to carry out the example methods described with reference to FIG. 2, and possibly any other processes or methods disclosed herein. In more detail, the apparatus 300 is operable to execute the methods described herein for receiving an indication to transmit one or more measurement reports, performing the necessary measurements, and transmitting the one or more measurement reports to a network node. It is also to be understood that the method of FIG. 2 is not necessarily carried out solely by apparatus 300. At least some operations of the method can be performed by one or more other entities. At least some operations of the method could be performed by one or more other entities.

Apparatus 121, also referred to as a virtual apparatus implemented in a wireless device (WD) or user equipment (UE), may comprise processing circuitry 11, which may include one or more microprocessor or microcontrollers, as well as other digital hardware, which may include digital signal processors (DSPs), special-purpose digital logic, and the like. The processing circuitry 11 may be configured to execute program code stored in memory 12, which may include one or several types of memory 12 such as read-only memory (ROM), random-access memory, cache memory, flash memory devices, optical storage devices, etc. Program code stored in memory 12 includes program instructions for executing one or more telecommunications and/or data communications protocols as well as instructions for carrying out one or more of the techniques described herein, in several embodiments. In some implementations, the processing circuitry 12 may be used to cause a receiving unit 91, a transmitting unit 92, an obtaining unit 93, and a measuring unit 94 and any other suitable units of apparatus 300 to perform corresponding functions according one or more embodiments of the present disclosure.

The wireless device may further comprise an antenna configured to send and receive wireless signals, radio front-end circuitry connected to the antenna and to processing circuitry, and configured to condition signals communicated between the antenna and the processing circuitry 11. The wireless device may further comprise an input interface connected to the processing circuitry 11 and configured to allow input of information into the wireless device to be processed by the processing circuitry 11, and an output interface connected to the processing circuitry and configured to output information from the wireless device that has been processed by the processing circuitry. Moreover, the wireless device may comprise a battery connected to the processing circuitry 11 and configured to supply power to the wireless device.

The above-described enhanced UL measurement framework may be used by a radio network node 110a capable of activating S205 one or more energy saving states with reduced capability by e.g. performing the steps of:
Before activating the one or more energy saving states, request (preconfigured) UE measurement reports from one or more UEs in RRC_CONNECTED state.
Evaluating the received measurement reports in order to determine one or more of the following:
   if some UEs may be served with sufficient Quality of Service (QoS) by other cells in the network,
   if said other cells will accept said UEs to be handed over, or
   if remaining UEs may be served with sufficient QoS given the reduced capabilities of the candidate energy saving mode.
Executing handover of selected UEs and entering the energy saving mode.

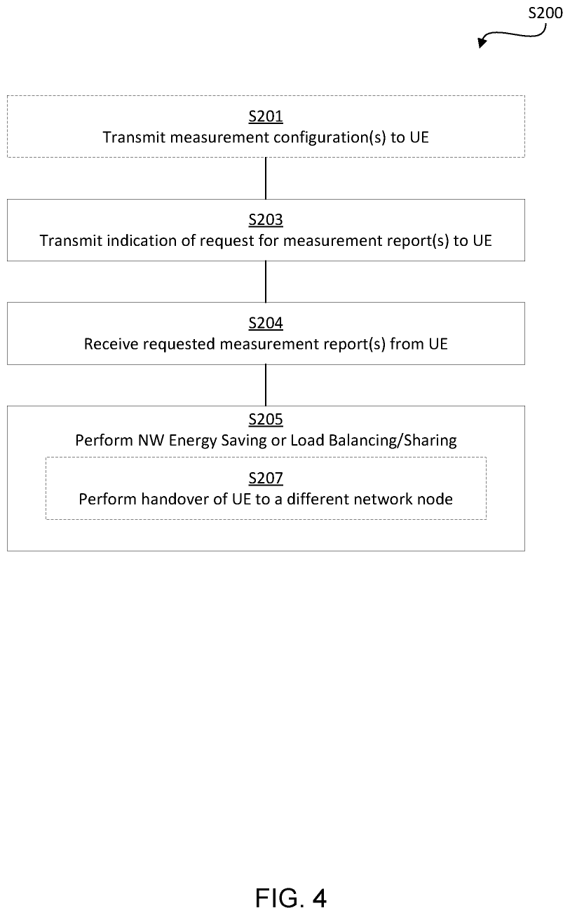

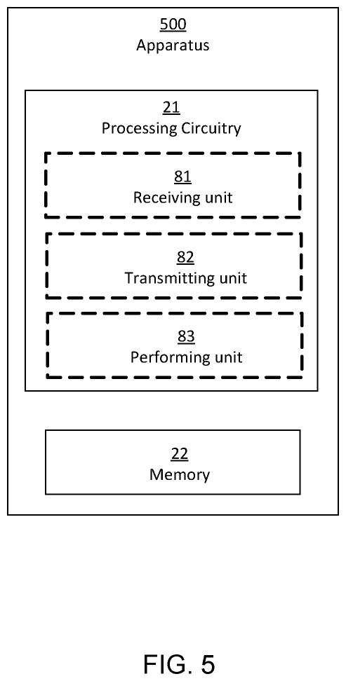

FIG. 4 is a schematic flowchart representation of a method S200 performed by a network node 110a for communicating with a wireless device in a wireless communication network in accordance with some embodiments. In short, the method S200 represents the “network-side” aspect of the foregoing disclosure, which was “client-side” or “UE-side” oriented. However, since many features and embodiments, for obvious reasons, are analogous, and for the reasons of clarity and conciseness they will not be repeated in explicit detail in the following. Thus, even if not explicitly mentioned in the following description with reference to FIGS. 4 and 5, corresponding features, preferred embodiments, and advantages as discussed in the foregoing are analogously applicable for the method S200 performed by the network node. As before, the following description is also made in reference to FIGS. 6-11 in order to facilitate the understanding of the herein disclosed technology for the reader.

The method S200 comprises transmitting, to the wireless device 121, a signal comprising an indication 103 of a request for one or more measurement reports, the one or more measurement reports being associated with one or more measurement configurations 101 of the wireless device 121. The method S200 further comprises S204 receiving the one or more measurement reports from the wireless device 121, and performing S205 a network energy saving function or a load balancing/sharing function based on the received one or more measurement reports.

The network energy saving function may comprise a spatial domain energy saving technique, such as e.g. turning off one or more RX/TX/TRX chains of the network node out of a plurality of RX/TX/TRX chains available to the network node. The term “turning off” one or more RX/TX/TRX chains may be understood as setting them in an idle/sleep mode, muting them, or turning off the associated circuitry. Moreover, the network energy saving function may comprise a time domain energy saving technique, such as e.g. setting one or more parts or functions of the network node in a sleep mode. The network energy saving function may comprise a power domain energy saving technique, such as e.g. reducing a transmission power for signals to be transmitted to a UE. Furthermore, the network energy saving function may comprise a frequency/carrier domain energy saving technique such as e.g. reducing a bandwidth (BW) for transmitting PDCCH to a UE, deactivating one or more SCells, configuring the network node so to transmit a lower number of RSs on one or more SCells. In some embodiments, the network energy saving function comprise a combination of some or all of the above-mentioned techniques.

Further, in some embodiments, the performing the network energy saving function and the load balancing/sharing function comprises handing over S207 the wireless device 121 to a neighboring cell based on the received S204 one or more measurement reports 105.

In some embodiments, the method S200 further comprises transmitting S201 the one or more measurement configurations 101 to the wireless device 121. The one or more measurement configurations may be re transmitted in an RRC measurement configuration framework, such as e.g. in a MeasConfig IE.

Moreover, in some embodiments, the MeasConfig Information Element comprises a corresponding Identification (ID) element, MeasID, for identifying each of the one or more measurement configurations 101. Accordingly, the indication 103 to of the request for the one or more measurement reports comprises one or more ID elements identifying the one or more measurement configurations 101 associated with the one or more measurement reports 105.

In some embodiments, the transmitted S203 signal, i.e. the signal comprising the indication 103, further comprises the one or more measurement configurations 101 associated with the one or more measurement reports 105. The transmitted S203 signal may be a physical layer signal (L1 signal), a MAC signal (L2 signal), or an RRC signal.

In some embodiments, each measurement report of the one or more measurement reports 105 is associated with one or more respective measurement report triggering criteria, and the one or more respective measurement criteria associated with each measurement report of the one or more measurement reports are indicated in the associated one or more measurement configurations 101. The one or more measurement report triggering criteria may be indicated in an RRC measurement configuration framework, such as e.g. in a MeasConfig Information Element. The one or more measurement report triggering criteria may be indicated in an extended MeasConfig Information Element.

In some embodiments, the network node 110a manages a cell serving a plurality of wireless devices, and the transmission S203 of the signal comprising the indication of the request for one or more measurement reports comprises transmitting S203 the signal to the plurality of wireless devices. Then, the indication 103 of the request for one or more measurement reports may be addressed to a specific subset of wireless devices of the plurality of wireless devices, and the receiving S204 the one or more measurement reports may comprise receiving one or more measurement reports only from the subset of wireless devices of the plurality of wireless devices.

In some embodiments, each wireless device of the plurality of wireless devices is associated with a subset of wireless devices out of a plurality of subsets of wireless devices. Here, each subset may have a corresponding group identification (ID) and the transmitted S203 signal may further comprise a specific group identification ID for addressing the specific subset of wireless devices of the plurality of wireless devices. A group or subset of wireless devices may for example comprise a specific type of wireless devices/UEs (e.g. URLLC UEs).

Moreover, in some embodiments, the network node manages a cell serving a plurality of wireless devices, where each wireless device of the plurality of wireless devices is associated with a subset of wireless devices out of a plurality of subsets of wireless devices, each subset being associated with a respective set of time resources or frequency resources. Here, the signal comprising the indication 103 of the request for one or more measurement reports is transmitted over one or more specific time resource or specific frequency resources so to address one or more specific subsets of the plurality of subsets. Accordingly, the step of receiving S204 the one or more measurement reports comprises receiving one or more measurement reports only from the one or more specific subsets of wireless devices of the plurality of wireless devices.

FIG. 5 is a schematic block diagram representation of embodiments of an apparatus 500 in a wireless communication network 100. The apparatus 500 may be implemented in a base station or network node (e.g. the network node 110a shown in FIG. 1). The apparatus 500 is operable to carry out the example methods described with reference to FIG. 4, and possibly any other processes or methods disclosed herein. In more detail, the apparatus 500 comprises processing circuitry 21 configured to transmit to a wireless device, a signal comprising an indication of a request for one or more measurement reports, the one or more measurement reports being associated with one or more measurement configurations of the wireless device. The processing circuitry is further configured to receiving the one or more measurement reports from the wireless device, performing a network energy saving function or a load balancing/sharing function based on the received one or more measurement reports. It is also to be understood that the method of FIG. 4 is not necessarily carried out solely by apparatus 500. At least some operations of the method may be performed by one or more other entities. At least some operations of the method may be performed by one or more other entities.

Apparatus 500, also referred to as a virtual apparatus implemented in a base station, may comprise processing circuitry 21, which may include one or more microprocessor or microcontrollers, as well as other digital hardware, which may include digital signal processors (DSPs), special-purpose digital logic, and the like. The processing circuitry 21 may be configured to execute program code stored in memory 22, which may include one or several types of memory such as read-only memory (ROM), random-access memory, cache memory, flash memory devices, optical storage devices, etc. Program code stored in memory 22 includes program instructions for executing one or more telecommunications and/or data communications protocols as well as instructions for carrying out one or more of the techniques described herein, in several embodiments. In some embodiments, the processing circuitry 21 may be used to cause a receiving unit 81, a transmitting unit 82, a performing unit 83 and any other suitable units of apparatus 500 to perform corresponding functions according one or more embodiments of the present disclosure.

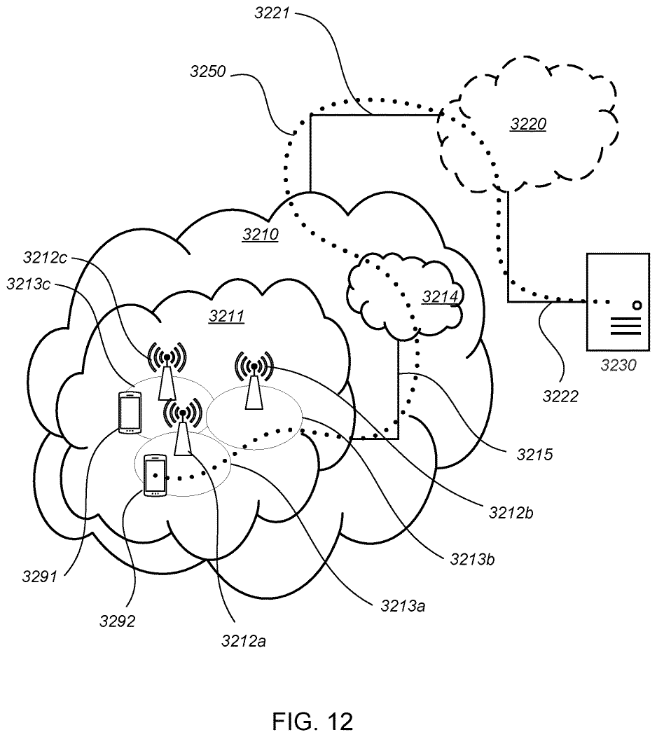

With reference to FIG. 12, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 12 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

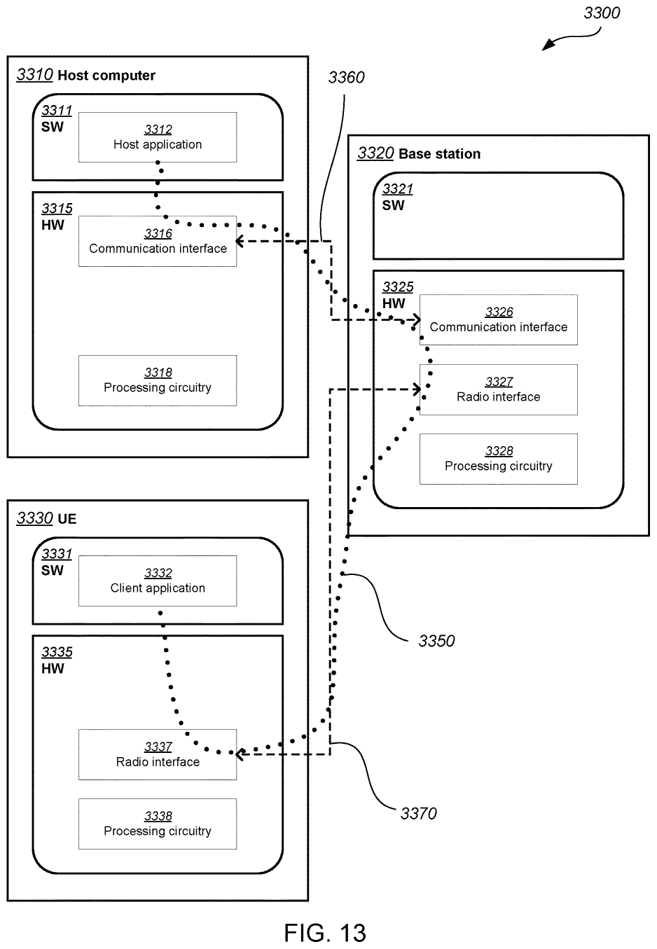

Example implementations, in accordance with an embodiment, of the UE, base station and host computer discussed in the preceding paragraphs will now be described with reference to FIG. 13. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 13) served by the base station 3320. The communication interface 3326 may be configured to facilitate a connection 3360 to the host computer 3310. The connection 3360 may be direct or it may pass through a core network (not shown in FIG. 13) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 13 may be identical to the host computer 3230, one of the base stations 3212a, 3212b, 3212c and one of the UEs 3291, 3292 of FIG. 12, respectively. This is to say, the inner workings of these entities may be as shown in FIG. 13 and independently, the surrounding network topology may be that of FIG. 12.

In FIG. 13, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the data rate and latency thereby provide benefits such as reduced user waiting time and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

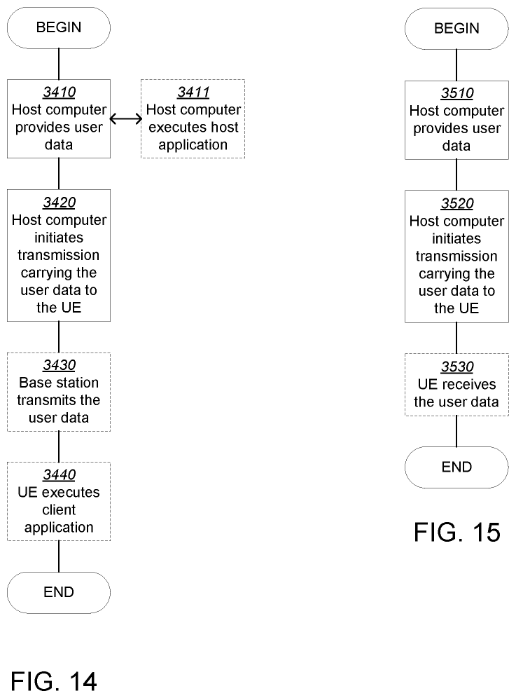

FIG. 14 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 14 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

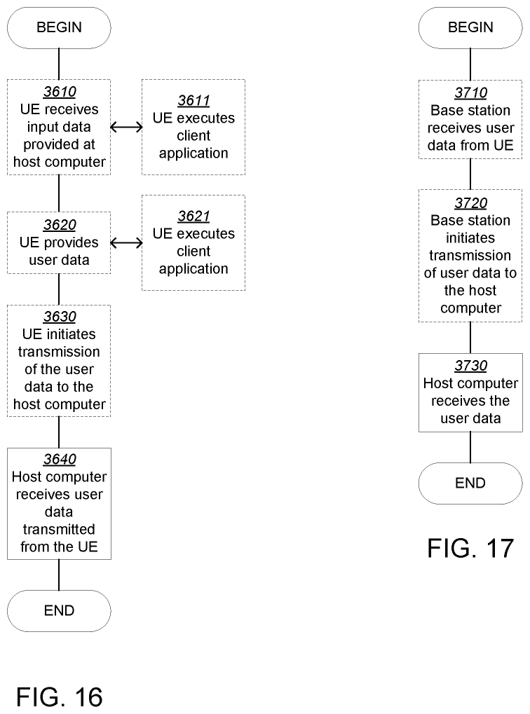

FIG. 16 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 16 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 17 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

Generally speaking, a computer-accessible medium may include any tangible or non-transitory storage media or memory media such as electronic, magnetic, or optical media—e.g., disk or CD/DVD-ROM coupled to computer system via bus. The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer-readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

Some preferred example embodiments of methods performed by a wireless device, wireless devices, methods performed by a network node, network nodes, and other related aspects are set out in summary form in the following clauses:

### Group A Clauses

A1. A method performed by a wireless device in a wireless communication network, the method comprising:
receiving a signal comprising an indication to transmit one or more measurement reports from a first network node or a second network node, wherein each measurement report is associated with a measurement configuration out of one or more measurement configurations;
transmitting the one or more measurement reports to the first network node or to the second network node.

A2. The method of clause A1, further comprising:
receiving the one or more measurement configurations from the first network node or the second network node.

A3. The method of clause A2, wherein the one or more measurement configurations are received in a Radio Resource Control, RRC, measurement configuration framework, such as e.g. in a MeasConfig Information Element.

A4. The method of any one of clause A2-A3, wherein the one or more measurement configurations is/are indicated in a MeasConfig Information Element;
wherein the MeasConfig Information Element comprises a corresponding Identification, ID, element, MeasID, for identifying each of the one or more measurement configurations; and
wherein the indication to transmit the one or more measurement reports comprises one or more ID elements identifying the one or more measurement configurations associated with the one or more measurement reports.

A5. The method of clause A1, wherein the received signal further comprises the one or more measurement configurations associated with the one or more measurement reports.

A6. The method of any one of clauses A1-A5, wherein the received signal is a physical layer signal or a Medium Access Control, MAC, signal.

A7. The method of any one of clauses A1-A5, wherein the received signal is a Radio Resource Control, RRC, signal.

A8. The method of any one of clauses A1-A7, wherein the first network node is a Centralized Unit, CU, of a radio base station and the second network node is a Distributed Unit, DU, of the radio base station.

A9. The method of any one of clauses A1-A8, wherein the first network node is a first radio base station and the second network node is a second radio base station.

A10. The method of any one of clauses A1-A9, further comprising:
performing measurements in accordance with the one or more measurement configurations that is/are associated with the indicated one or more measurement reports in order to generate the one or more measurement reports.

A11. The method of clause A10, wherein the measurements are performed in response to receiving the signal comprising the indication to transmit one or more measurement reports.

A12. The method of clause A10, wherein the measurements are performed prior to receiving the signal comprising the indication to transmit one or more measurement reports.

A13. The method of any one of clauses A1-A12, further comprising:
obtaining one or more measurement report triggering criteria for each measurement report of the one or more measurement reports;
wherein transmitting the measurement report is performed in response to the one or more measurement report triggering criteria being fulfilled.

A14. The method of clause A13, wherein the one or more measurement report triggering criteria is/are indicated in the associated one or more measurement configurations.

A15. The method of clause A13 or A14, wherein the one or more measurement report triggering criteria is/are indicated in an RRC measurement configuration framework, such as e.g. in a MeasConfig Information Element.

A16. The method of clause A15, wherein the one or more measurement report triggering criteria is/are indicated in an extended MeasConfig Information Element.

A17. The method of any one of clauses A13-A16, wherein the one or more measurement report triggering criteria comprises at least one of:
Reference Signal Received power, RSRP, of the first node is lower than a corresponding threshold;
Reference Signal Received power, RSRP, of the second node is higher than a corresponding threshold;
Reference Signal Received Quality, RSRQ, of the first node is lower than a corresponding threshold;
Reference Signal Received Quality, RSRQ, of the second node is higher than a corresponding threshold;
Signal to Interference plus Noise Ratio, SINR, of the first node is lower than a corresponding threshold;
Signal to Interference plus Noise Ratio, SINR, of the second node is higher than a corresponding threshold;
Uplink, UL, buffer data size is above a corresponding threshold;
UL buffer data size is below a corresponding threshold;
an inactivity timer of the wireless device is above a corresponding threshold;
an inactivity timer of the wireless device is below a corresponding threshold;
that a specific service or type of service is currently running or is currently not running;
a specific slice is currently active; or
a mobility state of the wireless device is at one state out of a plurality of predefined states.

A18. The method of any one of clauses A13-A17, further comprising:
performing measurements in order to evaluate a fulfilment of the one or more measurement report triggering criteria.

A19. The method of clause A18, wherein performing measurements in order to evaluate a fulfilment of the one or more measurement report triggering criteria is executed in response to receiving the signal comprising the indication to transmit one or more measurement reports.

A20. The method of any one of clauses A1-A19, wherein the wireless device is associated with a group of wireless devices out of a plurality of groups of wireless devices, each group having a corresponding group identification, ID, wherein the received signal further comprises an indication of a specific group ID, wherein the method further comprises:
checking if the specific group ID corresponds to the group ID that the wireless device is associated to;
in response to the group ID of the wireless device corresponding to the specific group ID:
   transmitting the one or more measurement reports to the first network node or to the second network node.

A21. The method of any one of the previous clauses in Group A, further comprising:
providing user data; and
forwarding the user data to a host computer via the transmission to a base station.

### Group B Clauses

B1. A method performed by a network node for communication with a wireless device in a wireless communication network, the method comprising:
transmitting, to the wireless device, a signal comprising an indication of a request for one or more measurement reports, the one or more measurement reports being associated with one or more measurement configurations of the wireless device;
receiving the one or more measurement reports from the wireless device;
performing a network energy saving function or a load balancing/sharing function based on the received one or more measurement reports.

B2. The method of clause B1, wherein the performing the network energy saving function and the load balancing/sharing function comprises:
handing over the wireless device to a neighbouring cell based on the received one or more measurement reports.

B3. The method of any one of clauses B1-B2, further comprising:
transmitting the one or more measurement configurations to the wireless device.

B4. The method of clause B3, wherein the one or more measurement configurations are transmitted in a Radio Resource Control, RRC, measurement configuration framework, such as e.g. in a MeasConfig Information Element.

B5. The method of any one of clauses B3-B4, wherein the one or more measurement configurations is/are indicated in a MeasConfig Information Element;
wherein the MeasConfig Information Element comprises a corresponding Identification, ID, element, MeasID, for identifying each of the one or more measurement configurations; and
wherein the indication to of the request for the one or more measurement reports comprises one or more ID elements identifying the one or more measurement configurations associated with the one or more measurement reports.

B6. The method of clause B1, wherein the transmitted signal further comprises the one or more measurement configurations associated with the one or more measurement reports.

B7. The method of any one of clauses B1-B6, wherein the transmitted signal is a physical layer signal or a Medium Access Control, MAC, signal.

B8. The method of any one of clauses B1-B6, wherein the transmitted signal is a Radio Resource Control, RRC, signal.

B9. The method of any one of clauses B1-B8, wherein each measurement report of the one or more measurement reports is associated with one or more respective measurement report triggering criteria; and wherein the one or more respective measurement criteria associated with each measurement report of the one or more measurement reports are indicated in the associated one or more measurement configurations.

B10. The method of clause B9, wherein the wherein the one or more measurement report triggering criteria is/are indicated in an RRC measurement configuration framework, such as e.g. in a MeasConfig Information Element.

B11. The method of clause B10, wherein the one or more measurement report triggering criteria is/are indicated in an extended MeasConfig Information Element.

B12. The method of any one of clauses B9-B11, wherein the wherein the one or more measurement report triggering criteria comprises at least one of:
Reference Signal Received power, RSRP, of the first node is lower than a corresponding threshold;
Reference Signal Received power, RSRP, of the second node is higher than a corresponding threshold;
Reference Signal Received Quality, RSRQ, of the first node is lower than a corresponding threshold;
Reference Signal Received Quality, RSRQ, of the second node is higher than a corresponding threshold;
Signal to Interference plus Noise Ratio, SINR, of the first node is lower than a corresponding threshold;
Signal to Interference plus Noise Ratio, SINR, of the second node is higher than a corresponding threshold;
Uplink, UL, buffer data size is above a corresponding threshold;
UL buffer data size is below a corresponding threshold;
an inactivity timer of the wireless device is above a corresponding threshold;
an inactivity timer of the wireless device is below a corresponding threshold;
that a specific service is currently running or is currently not running;
a specific slice is currently running or is currently not running; or
a mobility state of the wireless device is at one state out of a plurality of predefined states.

B13. The method of any one of clauses B1-B12, wherein the network node manages a cell serving a plurality of wireless devices, and wherein transmitting the signal comprising the indication of the request for one or more measurement reports comprises transmitting the signal to the plurality of wireless devices;
wherein the request for one or more measurement reports is addressed to a specific subset of wireless devices of the plurality of wireless devices; and
wherein receiving the one or more measurement reports comprises receiving one or more measurement reports only from the subset of wireless devices of the plurality of wireless devices.

B14. The method of clause B13, wherein each wireless device of the plurality of wireless devices is associated with a subset of wireless devices out of a plurality of subsets of wireless devices, each subset having a corresponding group identification, ID, wherein the transmitted signal further comprises a specific group identification ID for addressing the specific subset of wireless devices of the plurality of wireless devices.

B15. The method of clause B1-B12, wherein the network node manages a cell serving a plurality of wireless devices, wherein each wireless device of the plurality of wireless devices is associated with a subset of wireless devices out of a plurality of subsets of wireless devices, each subset being associated with a respective set of time resources or frequency resources;
wherein the signal comprising the indication of the request for one or more measurement reports is transmitted over one or more specific time resource or specific frequency resources so to address one or more specific subsets of the plurality of subsets;
wherein receiving the one or more measurement reports comprises receiving one or more measurement reports only from the one or more specific subsets of wireless devices of the plurality of wireless devices.

B16. The method of any one of the previous clauses in Group B, further comprising:
providing user data; and
forwarding the user data to a host computer or a wireless device.

### Group C Clauses

C1. A wireless device comprising:
processing circuitry configured to perform any of the steps of any of the Group A clauses; and
power supply circuitry configured to supply power to the wireless device.

C2. A base station comprising:
processing circuitry configured to perform any of the steps of any of the Group B clauses;
power supply circuitry configured to supply power to the wireless device.

C3. A user equipment (UE) for [insert purpose], the UE comprising:
an antenna configured to send and receive wireless signals;
radio frontend circuitry connected to the antenna and to processing circuitry, and configured to condition signals communicated between the antenna and the processing circuitry;
the processing circuitry being configured to perform any of the steps of any of the Group A clauses;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

C4. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B clauses.

C5. The communication system of clause C4 further including the base station.

C6. The communication system of any one of clauses C4-C5, further including the UE, wherein the UE is configured to communicate with the base station.

C7. The communication system of any one of clauses C4-C6, wherein:
the processing circuitry of the host computer is configured to execute a host application, thereby providing the user data; and
the UE comprises processing circuitry configured to execute a client application associated with the host application.

C8. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B clauses.

C9. The method of clause C8, further comprising, at the base station, transmitting the user data.

C10. The method of any one of clauses C8-C9, wherein the user data is provided at the host computer by executing a host application, the method further comprising, at the UE, executing a client application associated with the host application.

C11. A user equipment (UE) configured to communicate with a base station, the UE comprising a radio interface and processing circuitry configured to performs the method of any one of clauses C8-C10.

C12. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A clauses.

C13. The communication system of clause C12, wherein the cellular network further includes a base station configured to communicate with the UE.

C14. The communication system of any one of clauses C12-C13, wherein:
the processing circuitry of the host computer is configured to execute a host application, thereby providing the user data; and
the UE's processing circuitry is configured to execute a client application associated with the host application.

C15. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A

### CLAUSES

C16. The method of clause C15, further comprising at the UE, receiving the user data from the base station.

C17. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A clauses.

C18. The communication system of clause C17, further including the UE.

C19. The communication system of any one of clauses C17-C18, further including the base station, wherein the base station comprises a radio interface configured to communicate with the UE and a communication interface configured to forward to the host computer the user data carried by a transmission from the UE to the base station.

C20. The communication system of any one of clauses C17-C19, wherein:
the processing circuitry of the host computer is configured to execute a host application; and
the UE's processing circuitry is configured to execute a client application associated with the host application, thereby providing the user data.

C21. The communication system of any one of clauses C17-C20, wherein:
the processing circuitry of the host computer is configured to execute a host application, thereby providing request data; and
the UE's processing circuitry is configured to execute a client application associated with the host application, thereby providing the user data in response to the request data.

C22. A method implemented in a communication system including a host computer, a base station and a user equipment (UE), the method comprising:
at the host computer, receiving user data transmitted to the base station from the UE, wherein the UE performs any of the steps of any of the Group A clauses.

C23. The method of clause C22, further comprising, at the UE, providing the user data to the base station.

C24. The method of any one of clauses C22-C23, further comprising:
at the UE, executing a client application, thereby providing the user data to be transmitted; and
at the host computer, executing a host application associated with the client application.

C25. The method of any one of clauses C22-C24, further comprising:
at the UE, executing a client application; and
at the UE, receiving input data to the client application, the input data being provided at the host computer by executing a host application associated with the client application,
wherein the user data to be transmitted is provided by the client application in response to the input data.

C26. A user equipment (UE) configured to communicate with a base station, the UE comprising a radio interface and processing circuitry configured to performs the method of any one of clauses C22-C25.

C27. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B clauses.

C28. The communication system of clause C27, further including the base station.

C29. The communication system of any one of clause C27-C28, further including the UE, wherein the UE is configured to communicate with the base station.

C30. The communication system of any one of clause C27-C29, wherein:
the processing circuitry of the host computer is configured to execute a host application;
the UE is configured to execute a client application associated with the host application, thereby providing the user data to be received by the host computer.

C31. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A clauses.

C32. The method of clause C31, further comprising at the base station, receiving the user data from the UE.

C33. The method of any one of clause C31-C32, further comprising at the base station, initiating a transmission of the received user data to the host computer.

C34. A method implemented in a communication system including a host computer, a base station and a user equipment (UE), the method comprising:
at the host computer, receiving, from the base station, user data originating from a transmission which the base station has received from the UE, wherein the base station performs any of the steps described for the Group B clauses.

C35. The method of clause C34, further comprising at the base station, receiving the user data from the UE.

C36. The method of any one of clauses C34-C35, further comprising at the base station, initiating a transmission of the received user data to the host computer.

It should be noted that the word “comprising” does not exclude the presence of other elements or steps than those listed and the words “a” or “an” preceding an element do not exclude the presence of a plurality of such elements. It should further be noted that any reference signs do not limit the scope of the embodiments listed below, that the disclosure may be at least in part implemented by means of both hardware and software, and that several “means” or “units” may be represented by the same item of hardware.

It will also be understood that, although the term first, second, etc. may be used herein to describe various elements, these elements should not be limited by these terms. These terms are only used to distinguish one element from another. For example, a first array could be termed a second array, and, similarly, a second array could be termed a first array, without departing from the scope of the embodiments. The first array and the second array are both arrays, but they are not the same array.

As used herein, the terms “couple”, “coupled”, “connected”, and so forth are used to indicate that a first component and a second component out of multiple components are connected in a way such that a first component of the multiple components is capable of receiving a signal from a second component of the multiple components, unless indicated otherwise. In some cases, two components are indirectly coupled, indicating that one or more components (e.g., filters, waveguides, etc.) are located between the two components but a first component of the two components is capable of receiving signals from a second component of the two components.

Although the figures may show a specific order of method steps, the order of the steps may differ from what is depicted. In addition, two or more steps may be performed concurrently or with partial concurrence. All such variations are within the scope of the disclosure. Likewise, software implementations could be accomplished with standard programming techniques with rule-based logic and other logic to accomplish the various connection steps, processing steps, comparison steps and decision steps. The above mentioned and described embodiments are only given as examples and should not be limiting to the present disclosure. Other solutions, uses, objectives, and functions within the scope of the disclosure as defined in the below described patent embodiments should be apparent for the person skilled in the art.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination

### ABBREVIATIONS

5QI 5G QoS identifier
AMF Access and mobility management function
AS Access stratum
BW Bandwidth
BWP Bandwidth part
C-RNTI Cell radio network temporary identifier
M-RNTI MBMS radio network temporary identifier
CBR Channel busy ratio
CE Control Element
CHO Conditional handover
CLI Cross-link interference
CP Control Plane
CPC Continuous packet connectivity
CSI Channel state information
CSI-RS CSI reference signal
CU Centralized unit
CU-CP Central unit-Control plane
DCI Downlink Control Information
DL Downlink
DRB Data radio bearer
DU Distributed unit
E-UTRA Evolved UTRA
FDD Frequency division duplex
FR1 Frequency Range 1 in 5G NR
FR2 Frequency Range 2 in 5G NR
gNB Base station in NR
gNB Node for providing user plane and control plane protocol terminations
HOF Handover Failure
ID Identifier
IE Information Element
KgNB Key for gNB
LTE Long Term Evolution
MAC Medium access control
MBMS multimedia Broadcast/Multicast Service
MCG Master Cell Group
MCS Modulation and coding scheme
MHI Mobility History Report
MIMO Multiple input multiple output
MN Master Node
NR New Radio
NSSAI Network slice selection assistance information
OCT Octet
PBCH Physical broadcast channel
PCell Primary cell
PCI Physical cell identifier
PDCCH Physical downlink control channel
PDU Protocol data unit
PHY Physical layer
PRACH Physical random access channel
PSCell Primary and secondary cells
QoS Quality-of-service
RACH Random access channel
RAN Radio access network
RAT Radio access technology
RLF Radio Link Failure
RNTI Radio Network Temporary Identifier
RRC Radio resource control
RRM Radio resource management
RS Reference signal
RSRP Reference signal received power
RSRQ Reference signal received quality
RSSI Received signal strength indication
RX Receive
SCell Secondary cell
SCG Secondary Cell Group
SFN System frame number
SI Study item
SIB1 System information block 1
SN Secondary Node
SRB Signaling radio bearer
SRS Sounding reference signal
SS Synchronization signal
SSB System synchronization block
TDD Time division duplex
TX Transmit
UE User Equipment
UL Uplink
UPF User plane function
URLLC Ultra reliable low latency communication
UTRA Universal terrestrial radio access
WID Work item description

1. A method performable by a wireless device in a wireless communication network, the method comprising:
receiving a signal comprising an indication to transmit one or more measurement reports from a first network node or a second network node, wherein each measurement report is associated with a measurement configuration out of one or more measurement configurations; and
transmitting the one or more measurement reports to the first network node or to the second network node.

2. The method of claim 1, further comprising:
receiving the one or more measurement configurations from the first network node or the second network node.

3. The method of claim 2, wherein the one or more measurement configurations are received in a Radio Resource Control (RRC) measurement configuration framework.

4. The method of claim 2, wherein the one or more measurement configurations is/are indicated in a MeasConfig Information Element;
wherein the MeasConfig Information Element comprises a corresponding Identification (ID) element (MeasID) for identifying each of the one or more measurement configurations; and
wherein the indication to transmit the one or more measurement reports comprises one or more ID elements identifying the one or more measurement configurations associated with the one or more measurement reports.

5. The method of claim 1, wherein the received signal further comprises the one or more measurement configurations associated with the one or more measurement reports.

6. The method of claim 1, wherein the received signal is a physical layer signal or a Medium Access Control (MAC) signal.

7. The method of claim 1, wherein the received signal is a Radio Resource Control (RRC) signal.

8. The method of claim 1, wherein the first network node is a Centralized Unit (CU) of a radio base station and the second network node is a Distributed Unit (DU) of the radio base station.

9. The method of claim 1, wherein the first network node is a first radio base station and the second network node is a second radio base station.

10. The method of claim 1, further comprising:
performing measurements in accordance with the one or more measurement configurations that is/are associated with the indicated one or more measurement reports in order to generate the one or more measurement reports.

11. The method of claim 10, wherein the measurements are performed in response to receiving the signal comprising the indication to transmit one or more measurement reports.

12. The method of claim 10, wherein the measurements are performed prior to receiving the signal comprising the indication to transmit one or more measurement reports.

13. The method of claim 1, further comprising:
obtaining one or more measurement report triggering criteria for each measurement report of the one or more measurement reports;
wherein transmitting the measurement report is performed in response to the one or more measurement report triggering criteria being fulfilled.

14. The method of claim 13, wherein the one or more measurement report triggering criteria is/are indicated in the associated one or more measurement configurations.

15. The method of claim 13, wherein the one or more measurement report triggering criteria is/are indicated in an RRC measurement configuration framework, such as e.g. in a MeasConfig Information Element.

16. The method of claim 1, wherein the one or more measurement report triggering criteria is/are indicated in an extended MeasConfig Information Element.

17. The method of claim 13, wherein the one or more measurement report triggering criteria comprises at least one of:
Reference Signal Received power (RSRP) of the first node is lower than a corresponding threshold;
Reference Signal Received power (RSRP) of the second node is higher than a corresponding threshold;
Reference Signal Received Quality (RSRQ) of the first node is lower than a corresponding threshold;
Reference Signal Received Quality (RSRQ) of the second node is higher than a corresponding threshold;
Signal to Interference plus Noise Ratio (SINR) of the first node is lower than a corresponding threshold;
Signal to Interference plus Noise Ratio (SINR) of the second node is higher than a corresponding threshold;
Uplink (UL) buffer data size is above a corresponding threshold;
UL buffer data size is below a corresponding threshold;
an inactivity timer of the wireless device is above a corresponding threshold;
an inactivity timer of the wireless device is below a corresponding threshold;
that a specific service or type of service is currently running or is currently not running;
a specific slice is currently active; or
a mobility state of the wireless device is at one state out of a plurality of predefined states.

18. The method of claim 13, further comprising:
performing measurements in order to evaluate a fulfilment of the one or more measurement report triggering criteria.

19.-22. (canceled)

23. A wireless device comprising one or more processors configured to:
receive a signal comprising an indication to transmit one or more measurement reports from a first network node or a second network node, wherein each measurement report is associated with a measurement configuration out of one or more measurement configurations; and
transmit the one or more measurement reports to the first network node or to the second network node.

24. A method performed by a network node for communication with a wireless device in a wireless communication network, the method comprising:
transmitting, to the wireless device, a signal comprising an indication of a request for one or more measurement reports, the one or more measurement reports being associated with one or more measurement configurations of the wireless device;
receiving the one or more measurement reports from the wireless device; and
performing a network energy saving function or a load balancing/sharing function based on the received one or more measurement reports.

25.-41. (canceled)
